(19) United States
(12) Patent Application Publication
(10) Pub. No.: US 2019/0171611 A1
(43) Pub. Date: Jun. 6, 2019

(54) PROTOCOL-FRAMED CLOCK LINE DRIVING FOR DEVICE COMMUNICATION OVER MASTER-ORIGINATED CLOCK LINE

(71) Applicant: QUALCOMM Incorporated, San Diego, CA (US)

(72) Inventors: Lalan Jee MISHRA, San Diego, CA (US); Richard Dominic WIETFELDT, San Diego, CA (US)

(21) Appl. No.: 16/162,524

(22) Filed: Oct. 17, 2018

Related U.S. Application Data
(60) Provisional application No. 62/594,964, filed on Dec. 5, 2017.
(60) Provisional application No. 62/594,975, filed on Dec. 5, 2017.

(51) Int. Cl. G06F 13/42; G06F 13/374; G06F 13/40; G06F 13/38

(52) U.S. Cl. CPC G06F 13/4291; G06F 13/385; G06F 13/4036; G06F 13/374

(57) ABSTRACT

Systems, methods, and apparatus are described that enable a serial bus to be operated in one or more modes that employ additional wires for communicating data. A method for transmitting data over a serial bus includes receiving from a first line of the serial bus a clock signal used for timing transmission of data on a second line of the serial bus, activating a driver after the first line has transitioned from a first signaling state to a second signaling state while the data is being transmitted on the second line, driving the first line to the first signaling state to transmit a first bit of data when the first bit of data has a first value, and refraining from driving the first line to the first signaling state to transmit a first bit of data when the first bit of data has a second value.

### PRIORITY CLAIM

This application claims priority to and the benefit of U.S. Provisional Patent Application Ser. No. 62/594,964 filed in the U.S. Patent Office on Dec. 5, 2017 and of U.S. Provisional Patent Application Ser. No. 62/594,975 filed in the U.S. Patent Office on Dec. 5, 2017, the entire content of these applications being incorporated herein by reference as if fully set forth below in its entirety and for all applicable purposes.

### TECHNICAL FIELD

The present disclosure relates generally to an interface between processing circuits and peripheral devices and, more particularly, to reducing latency and expanding data communication throughput on a serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, such as a multi-drop serial bus or a parallel bus. General-purpose serial interfaces are known in the industry, including the Inter-Integrated Circuit (I2C or I²C) serial bus and its derivatives and alternatives. Certain serial interface standards and protocols are defined by the Mobile Industry Processor Interface (MIPI) Alliance, including the I3C, system power management interface (SPMI), and the Radio Frequency Front-End (RFFE) interface standards and protocols.

The I2C bus is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

The protocols used on an I3C bus derive certain implementation aspects from the I2C protocol. Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

The RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links.

The SPMI standards provide a hardware interface that may be implemented between baseband or application processors and peripheral components. In some implementations, the SPMI is deployed to support power management operations within a device.

Multi-drop buses such as I2C, I3C, RFFE, SPMI, etc. operate in half-duplex mode, and typically do not efficiently handle urgent requests for access to the bus by devices with high-priority data for transmission. As applications have become more complex, demand for throughput over the serial bus can escalate and capacity continues to rise and there is a continuing demand for improved bus management techniques.

### SUMMARY

Certain aspects of the disclosure relate to systems, apparatus, methods and techniques that enable alerts and/or requests for bus arbitration to be sent in a first direction over a serial bus while a datagram is being transmitted in a second direction over the serial bus.

In various aspects of the disclosure, a method for transmitting data over a serial bus includes receiving a clock signal on a first line of the serial bus. Data is transmitted on a second line of the serial bus in accordance with timing provided by the clock signal, activating a driver after the first line has transitioned from a first signaling state to a second signaling state while the data is being transmitted on the second line, driving the first line to the first signaling state to transmit a first bit of data when the first bit of data has a first value, and refraining from driving the first line to the first signaling state to transmit a first bit of data when the first bit of data has a second value.

In various aspects of the disclosure, an apparatus adapted for communicating over a serial bus includes a processor configured to provide an alert code for transmission over a first line of a serial bus while data is transmitted by another device over a second line of the serial bus, and an interface circuit adapted to couple the apparatus to a serial bus. The interface circuit may have a line driver coupled to the first line of the serial bus. The data may be transmitted over the second line of the serial bus in accordance with timing provided by a clock signal received from the first line of the serial bus. The interface circuit is configured to detect that the clock signal has transitioned from a first signaling state to a second signaling state while the data is being transmitted over the second line, activate the line driver after the first line of the serial bus has transitioned from the first signaling state to the second signaling state when a first bit of the alert code has a first value, drive the first line of the serial bus to the first signaling state to transmit a first bit of data when the first bit of the alert code has the first value, and refrain from driving the first line when the first bit of data of the alert code has a second value.

In various aspects of the disclosure, a method implemented at a first device coupled to a serial bus includes participating in a transaction with a second device coupled to the serial bus in which a first datagram is transmitted over a first line of the serial bus in accordance with a clock signal transmitted by a master device on a second line of the serial device, and transmitting a second datagram by pulse width modulating the clock signal while the first datagram is being transmitted. A bit of the second datagram is encoded in the clock signal by detecting a first edge in the clock signal, where the master device is configured to enter a high impedance state with respect to the second line after driving the first edge. The second line may be driven to generate a second edge in the clock signal when the bit has a first value, and the first device may refrain from driving the second line when the bit has a second value.

In various aspects of the disclosure, an apparatus operable for transmitting data over a serial bus has a bus interface configured to couple the apparatus to the serial bus and a controller. The bus interface may have a line driver adapted to drive a first line of the serial bus. The controller may be configured to participate in a transaction with another device coupled to the serial bus in which a first datagram is transmitted over the first line of the serial bus in accordance with a clock signal transmitted by a master device on a second line of the serial bus, and cause the bus interface to pulse width modulate each bit of a second datagram. Pulse width modulation may be accomplished by detecting a first edge in the clock signal, where the master device is configured to enter a high impedance state with respect to the second line after driving the first edge, driving the second line to generate a second edge in the clock signal when the bit has a first value, and refraining from driving the second line when the bit has a second value.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates a system architecture for an apparatus employing a data link between IC devices.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a command word sent to a slave device in accordance with I2C protocols.

FIG. 7 includes a timing diagram that illustrates signaling on a serial bus when the serial bus is operated in a single data rate (SDR) mode of operation defined by I3C specifications.

FIG. 8 illustrates an example of signaling transmitted on the Data wire and Clock wire of a serial bus to initiate certain mode changes.

FIG. 9 illustrates the timing of additional pulses that may be added to a clock signal in accordance with certain aspects disclosed herein.

FIG. 10 illustrates a first example of the use of additional pulses that may be added to a clock signal in accordance with certain aspects disclosed herein.

FIG. 11 illustrates a communication interface in which a plurality of devices is connected using a serial bus adapted to carry additional pulses in a clock signal in accordance with certain aspects disclosed herein.

FIG. 12 illustrates a second example of the use of additional pulses that may be added to a clock signal in accordance with certain aspects disclosed herein.

FIG. 13 is a flowchart illustrating a process for transferring bus ownership in accordance with certain aspects disclosed herein.

FIG. 14 illustrates certain aspects of a PWM-based signaling scheme in accordance with certain aspects disclosed herein.

FIG. 15 illustrates an example of an alert transmission by a slave device or secondary master device in accordance with certain aspects disclosed herein.

FIG. 16 illustrates a process that may be used to handle arbitration/alert bytes generated from PWM encoding on the clock signal.

FIG. 17 illustrates a second example of alert transmissions by a slave device or secondary master device.

FIG. 18 illustrates timing of additional clock cycles that may be transmitted to support full-duplex emulation in accordance with certain aspects disclosed herein.

FIG. 19 illustrates a process that may be used to implement full-duplex emulation in accordance with certain aspects disclosed herein.

FIG. 20 is a block diagram illustrating an example of an apparatus employing a processing circuit that may be adapted according to certain aspects disclosed herein.

FIG. 21 is a flowchart illustrating a first process that may be performed at a device coupled to a serial bus in accordance with certain aspects disclosed herein.

FIG. 22 is a flowchart illustrating a second process that may be performed at a master device coupled to a serial bus in accordance with certain aspects disclosed herein.

FIG. 23 is a flowchart illustrating a third process that may be performed at a transmitting device coupled to a serial bus in accordance with certain aspects disclosed herein.

FIG. 24 illustrates a hardware implementation for a transmitting apparatus adapted to respond to support multi-line operation of a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect application processor or other host device with modems and other peripherals. The serial bus may be operated in accordance with specifications and protocols defined by a standards body. The serial bus may be operated in accordance with a standard or protocol such as the I2C, I3C, serial low-power inter-chip media bus (SLIMbus), system management bus (SMB), RFFE and SPMI protocols that define timing relationships between signals and transmissions. Certain aspects disclosed herein relate to systems, apparatus, methods and techniques that provide a mechanism that can be used on a serial bus to provide alert opportunities that may be employed that improve link performance. Certain aspects are described in relation to a serial bus that is operated in accordance with I3C protocols.

A device that has data to be communicated over a half-duplex serial bus must wait for an ongoing transmission to be completed before accessing the serial bus, regardless of the priority of the data to be communicated. Many applications and devices having an absolute or urgent need may pre-empt the bus through an arbitration/pre-emption indication. For example, applications and/or devices may generate and/or require access to real-time data without undue delay (i.e. latency). Certain deterministic applications have strict requirements for latency that may be jeopardized when a device cannot quickly access the serial bus because conventional protocols require that transmission of a current datagram be completed before access to the serial bus is granted irrespective of the priority of the current datagram. In some systems, additional hardware lines may be provided to enable bus preemption. The additional lines add to circuit complexity and cost.

According to certain aspects disclosed herein, an in-band alert mechanism can be provided to allow preemption. Preemption can reduce the number of clock cycles to accomplish datagram pre-emption and/or master ownership hand-off in order to minimize bus latency.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

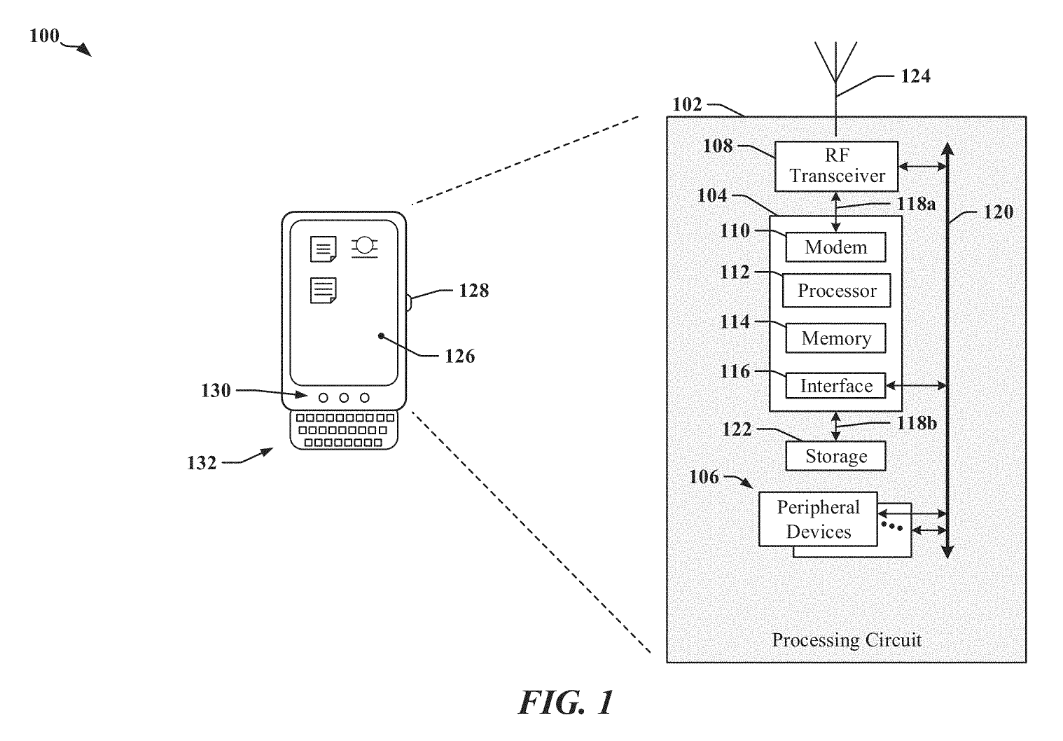

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

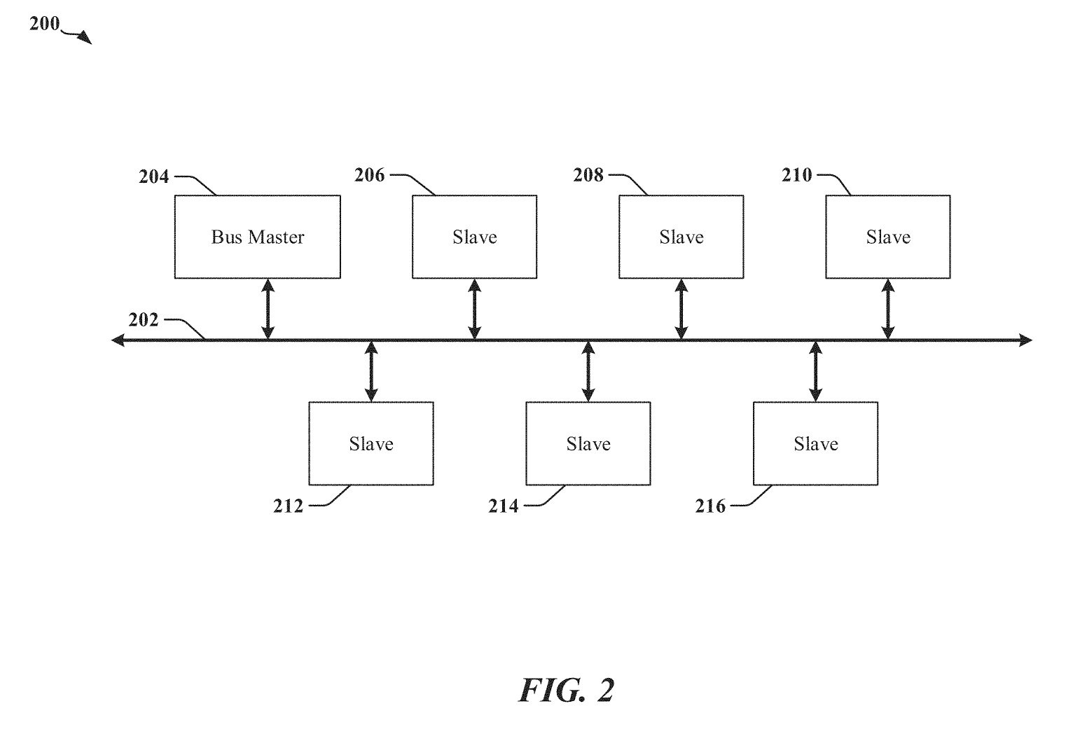

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

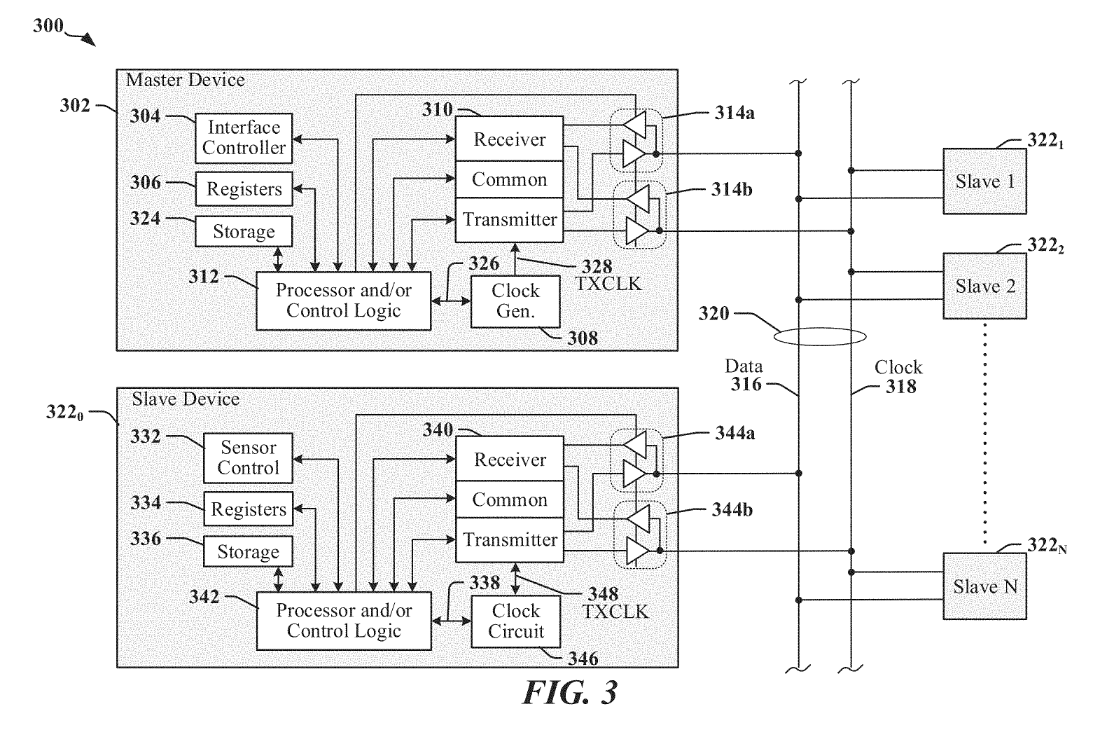

FIG. 3 illustrates certain aspects of an apparatus 300 that includes multiple devices 302, and 322₀-322_{N} coupled to a serial bus 320. The devices 302 and 322₀-322_{N} may be implemented in one or more semiconductor IC devices, such as an application processor, SoC or ASIC. In various implementations the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communications between devices 302 and 322₀-322_{N} over the serial bus 320 is controlled by a bus master device 302. Certain types of bus can support multiple bus master devices 302.

In one example, a bus master device 302 may include an interface controller 304 that manages access to the serial bus, configures dynamic addresses for slave devices 322₀-322_{N} and/or generates a clock signal 328 to be transmitted on a clock line 318 of the serial bus 320. The bus master device 302 may include configuration registers 306 or other storage 324, and other control logic 312 configured to handle protocols and/or higher level functions. The control logic 312 may include a processing circuit having a processing device such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clock signals 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit having a processing device such as a state machine, sequencer, signal processor or general-purpose processor. The transceiver 340 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. The clock signal 348 may be derived from a signal received from the clock line 318. Other timing clock signals 338 may be used by the control logic 342 and other functions, circuits or modules.

The serial bus 320 may be operated in accordance with RFFE, I2C, I3C, SPMI, or other protocol. In some instances, two or more devices 302, 322₀-322_{N} may be configured to operate as a bus master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, data is transmitted on a data line 316 of the serial bus 320 based on timing information provided in a clock signal transmitted on the clock line 318 of the serial bus 320. In some instances, data may be encoded in the signaling state, or transitions in signaling state of both the data line 316 and the clock line 318.

### Examples of Signaling on a Serial Bus

Examples of data transfers including control signaling, command and payload transmissions are provided by way of example. The examples illustrated relate to I2C and I3C communication to facilitate description of certain aspects of this disclosure. However, the concepts disclosed herein may be applicable to other bus configurations and protocols, including RFFE and SPMI bus configurations.

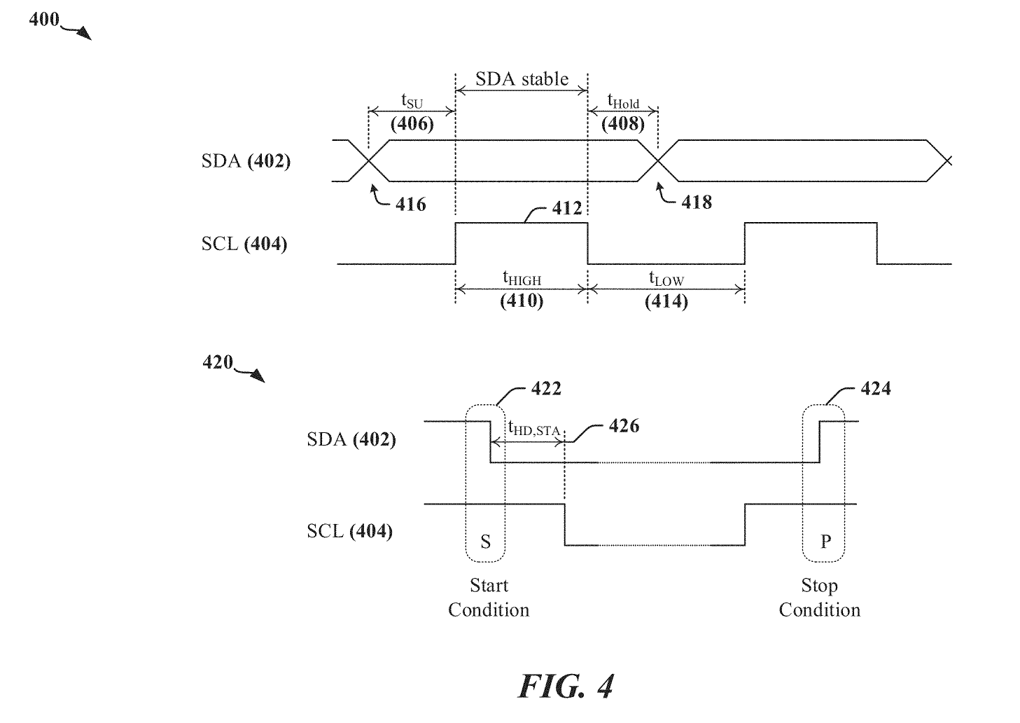

FIG. 4 includes timing diagrams 400 and 420 that illustrate the relationship between the SDA wire 402 and the SCL wire 404 on a conventional I2C bus. The first timing diagram 400 illustrates the timing relationship between the SDA wire 402 and the SCL wire 404 while data is being transferred on the conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid; the state of the SDA wire 402 is not permitted to change when the SCL wire 404 is in the high logic state.

Specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

The second timing diagram 420 of FIG. 4 illustrates signaling states on the SDA wire 402 and the SCL wire 404 between data transmissions on a conventional I2C bus. The I2C protocol provides for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

A start condition 422 is defined to permit the current bus master to signal that data is to be transmitted. The start condition 422 occurs when the SDA wire 402 transitions from high to low while the SCL wire 404 is high. The I2C bus master initially transmits the start condition 422, which may be also be referred to as a start bit, followed by a 7-bit address of an I2C slave device with which it wishes to exchange data. The address is followed by a single bit that indicates whether a read or write operation is to occur. The addressed I2C slave device, if available, responds with an ACK bit. If no I2C slave device responds, the I2C bus master may interpret the high logic state of the SDA wire 402 as a NACK. After transmission of an ACK, the master and slave devices may exchange bytes of information in frames, in which the bytes are serialized such that the most significant bit (MSB) is transmitted first. The transmission of the byte is completed when a stop condition 424 is transmitted by the I2C master device. The stop condition 424 occurs when the SDA wire 402 transitions from low to high while the SCL wire 404 is high. The I2C Specifications require that all transitions of the SDA wire 402 occur when the SCL wire 404 is low, and exceptions may be treated as a start condition 422 or a stop condition 424.

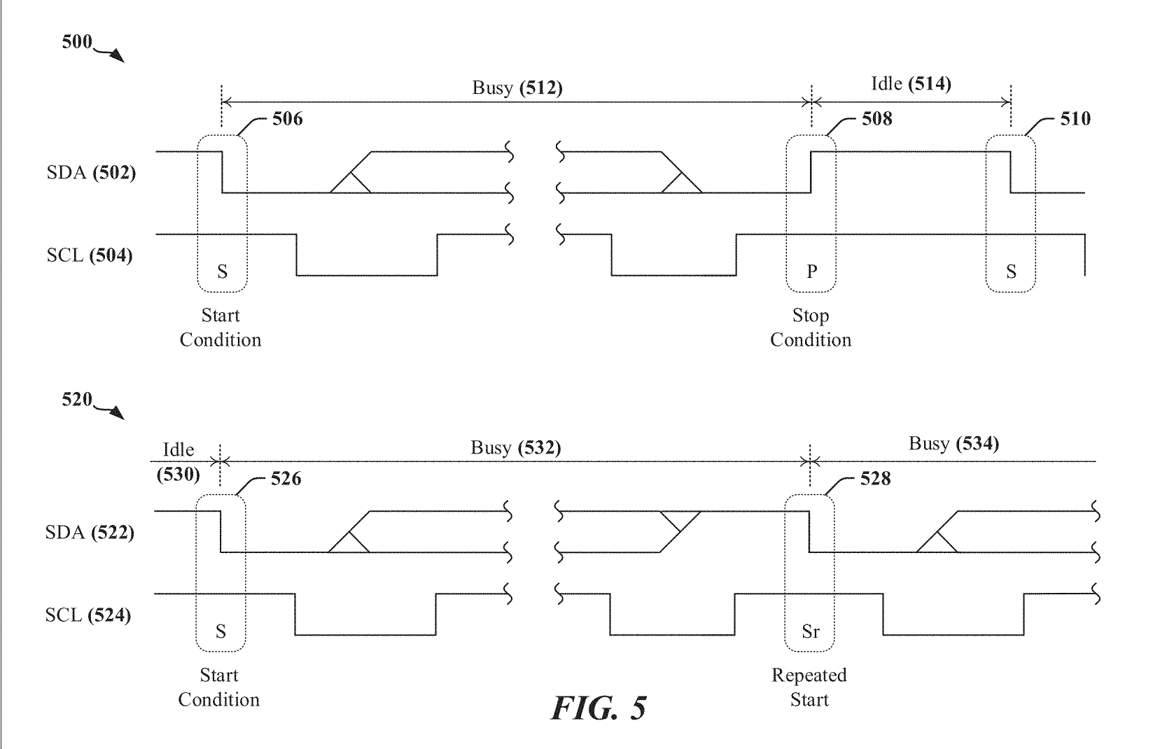

FIG. 5 includes diagrams 500 and 520 that illustrate timing associated with data transmissions on an I2C bus. As illustrated in the first diagram 500, an idle period 514 may occur between a stop condition 508 and a consecutive start condition 510. This idle period 514 may be prolonged, and may result in reduced data throughput when the conventional I2C bus remains idle between the stop condition 508 and the consecutive start condition 510. In operation, a busy period 512 commences when the I2C bus master transmits a first start condition 506, followed by data. The busy period 512 ends when the I2C bus master transmits a stop condition 508 and the idle period 514 ensues. The idle period 514 ends when a second start condition 510 is transmitted.

The second timing diagram 520 illustrates a method by which the number of occurrences of an idle period 514 may be reduced. In the illustrated example, data is available for transmission before a first busy period 532 ends. The I2C bus master device may transmit a repeated start condition 528 (Sr) rather than a stop condition. The repeated start condition 528 terminates the preceding data transmission and simultaneously indicates the commencement of a next data transmission. The state transition on the SDA wire 522 corresponding to the repeated start condition 528 is identical to the state transition on the SDA wire 522 for a start condition 526 that occurs after an idle period 530. For both the start condition 526 and the repeated start condition 528, the SDA wire 522 transitions from high to low while the SCL wire 524 is high. When a repeated start condition 528 is used between data transmissions, a first busy period 532 is immediately followed by a second busy period 534.

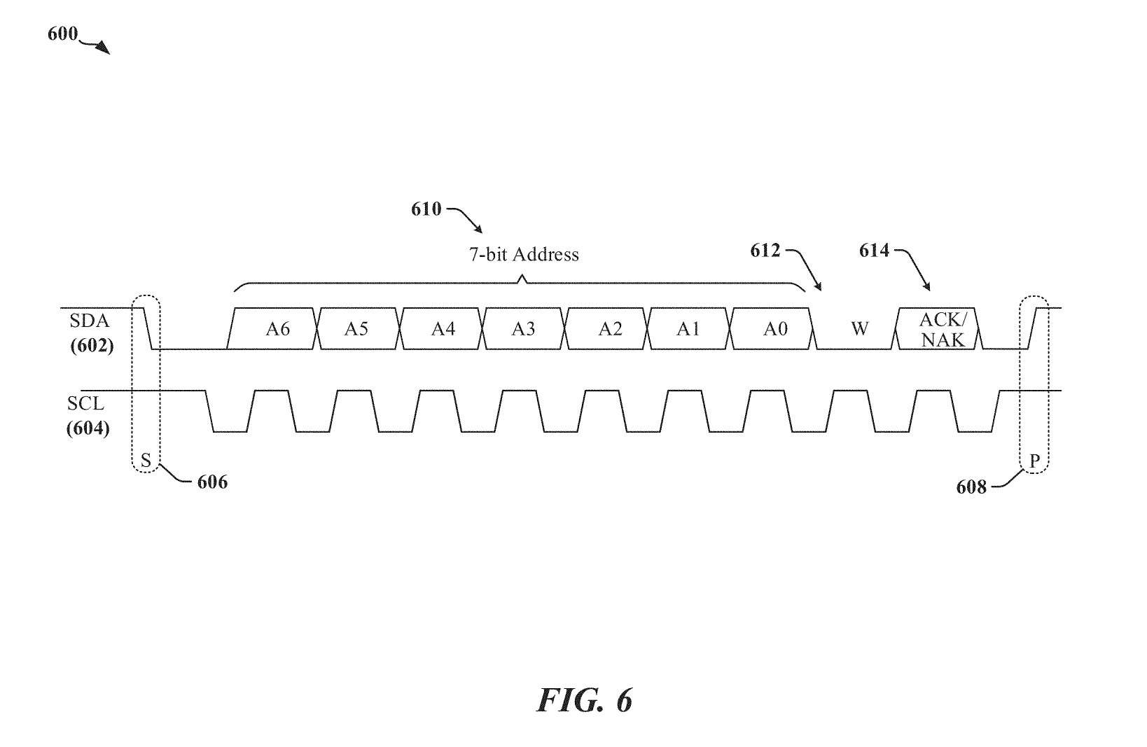

FIG. 6 is a diagram 600 that illustrates an example of the timing associated with a command word sent to a slave device in accordance with I2C protocols. In the example, a master device initiates the transaction with a start condition 606, whereby the SDA wire 602 is driven from high to low while the SCL wire 604 remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. The master device may terminate the transaction with a stop condition 608 by driving the SDA wire 602 from low to high while the SCL wire 604 is high. This transaction can be used to determine whether a slave device with the transmitted address coupled to the I2C bus is in an active state.

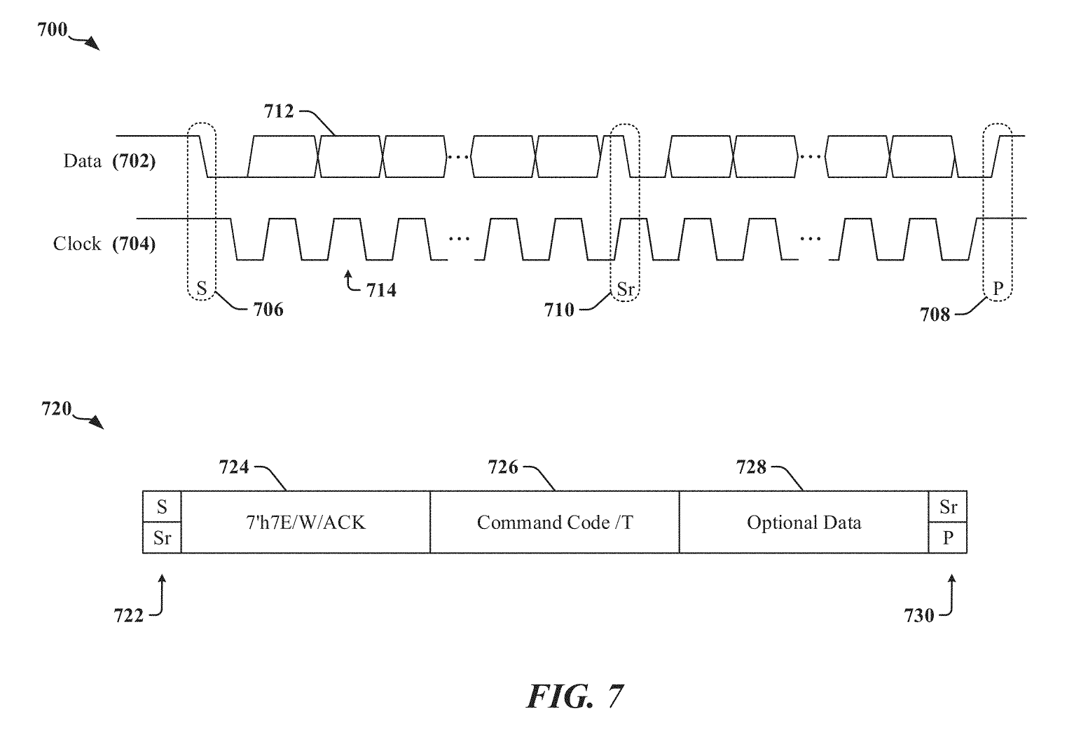

FIG. 7 includes a timing diagram 700 that illustrates signaling on a serial bus when the serial bus is operated in a single data rate (SDR) mode of operation defined by I3C specifications. Data transmitted on a first wire (the Data wire 702) of the serial bus may be captured using a clock signal transmitted on a second wire (the Clock wire 704) of the serial bus. During data transmission, the signaling state 712 of the Data wire 702 is expected to remain constant for the duration of the pulses 714 when the Clock wire 704 is at a high voltage level. Transitions on the Data wire 702 when the Clock wire 704 is at the high voltage level indicate a START condition 706, a STOP condition 708 or a repeated START 710.

On an I3C serial bus, a START condition 706 is defined to permit the current bus master to signal that data is to be transmitted. The START condition 706 occurs when the Data wire 702 transitions from high to low while the Clock wire 704 is high. The bus master may signal completion and/or termination of a transmission using a STOP condition 708. The STOP condition 708 is indicated when the Data wire 702 transitions from low to high while the Clock wire 704 is high. A repeated START 710 may be transmitted by a bus master that wishes to initiate a second transmission upon completion of a first transmission. The repeated START 710 is transmitted instead of, and has the significance of a STOP condition 708 followed immediately by a START condition 706. The repeated START 710 occurs when the Data wire 702 transitions from high to low while the Clock wire 704 is high.

The bus master may transmit an initiator 722 that may be a START condition 706 or a repeated START 710 prior to transmitting an address of a slave, a command, and/or data. FIG. 7 illustrates a command code transmission 720 by the bus master. The initiator 722 may be followed in transmission by a predefined command 724 indicating that a command code 726 is to follow. The command code 726 may, for example, cause the serial bus to transition to a desired mode of operation. In some instances, data 728 may be transmitted. The command code transmission 720 may be followed by a terminator 730 that may be a STOP condition 708 or a repeated START 710.

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal.

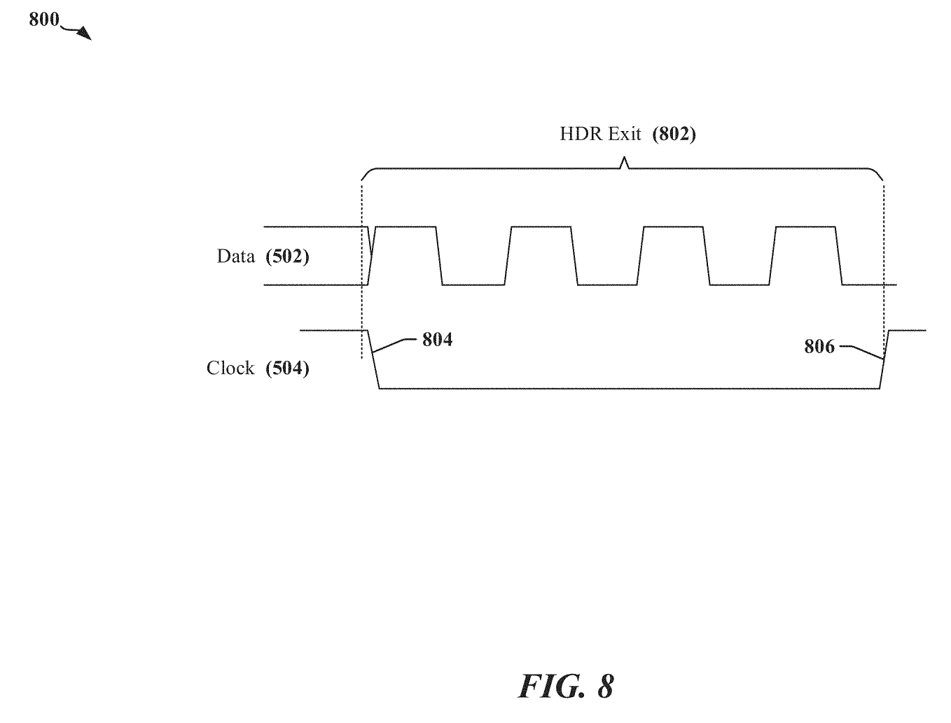

FIG. 8 illustrates an example of signaling 800 transmitted on the Data wire 504 and Clock wire 502 to initiate certain mode changes. The signaling 800 is defined by I3C protocols for use in initiating restart, exit and/or break from I3C HDR modes of communication. The signaling 800 includes an HDR Exit 802 that may be used to cause an HDR break or exit. The HDR Exit 802 commences with a falling edge 804 on the Clock wire 502 and ends with a rising edge 806 on the Clock wire 502. While the Clock wire 502 is in low signaling state, four pulses are transmitted on the Data wire 504. I2C devices ignore the Data wire 504 when no pulses are provided on the Clock wire 502.

In another HDR mode, I3C specifications define a ternary encoding scheme in which transmission of a clock signal is suspended and data is encoded in symbols that define signals that are transmitted over the clock and data lines. Clock information is encoded by ensuring that a transition in signaling state occurs at each transition between two consecutive symbols.

### PPM Pre-Emption Requests Transmitted on a Clock Line of a Serial Bus

Certain aspects disclosed herein relate to the use of pulse position modulation to provide a multipurpose signaling scheme on a multi-point serial bus that couples multiple devices. In one example, one or more pulses may be launched while the clock wire is in a low (‘0’) signaling state. In another example, one or more pulses may be launched while the clock wire is in a high (‘1’) signaling state.

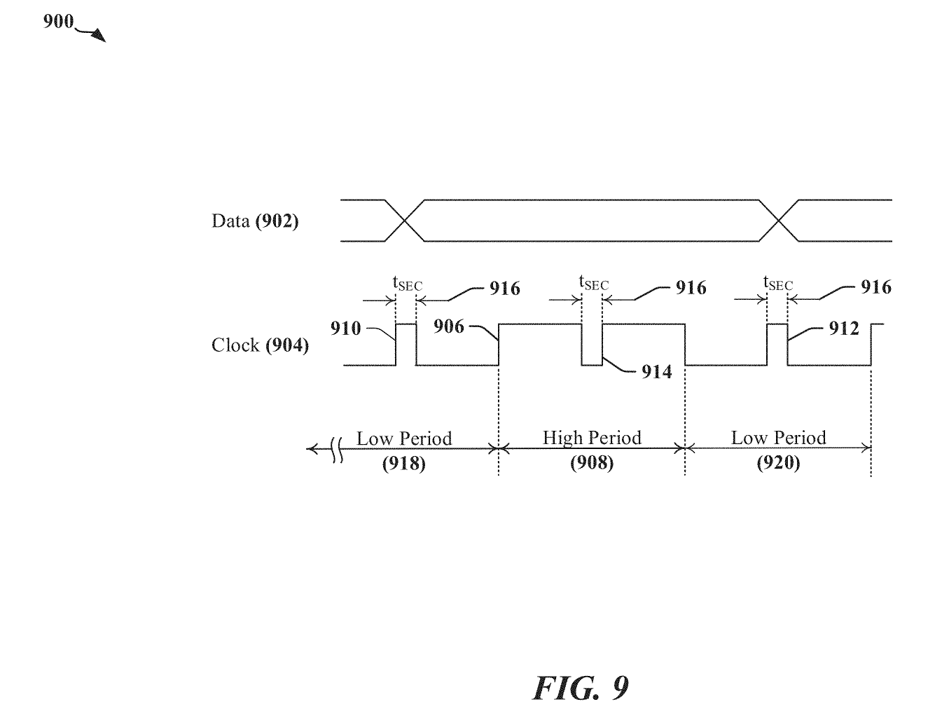

FIG. 9 is a timing diagram 900 that illustrates the timing of additional pulses 910, 912, 914 that may be added to a clock signal 904 in accordance with certain aspects disclosed herein. In some implementations, conventional I2C devices may be unable to recognize PPM signaling on the clock signal 904. Conventional I2C devices may include a spike filter that causes the additional pulses 910, 912, 914 to be filtered by the bus interface of legacy I2C devices when the duration 916 of the additional pulses 910, 912, 914 is less than the minimum duration specified for a pulse by the I2C protocol. The clock signal 904 may carry one or more pulses 906 that are used to sample and/or capture data 902. These pulses 906 may have a high period 908 of a duration that exceeds the minimum duration specified for a pulse by the I2C protocol. The low period 918 preceding the pulse and the low period 920 following the pulse have durations that exceed the minimum low duration specified by the I2C protocol. In the timing diagram 900, additional pulses 910, 912, 914 may be transmitted on the clock signal 904.

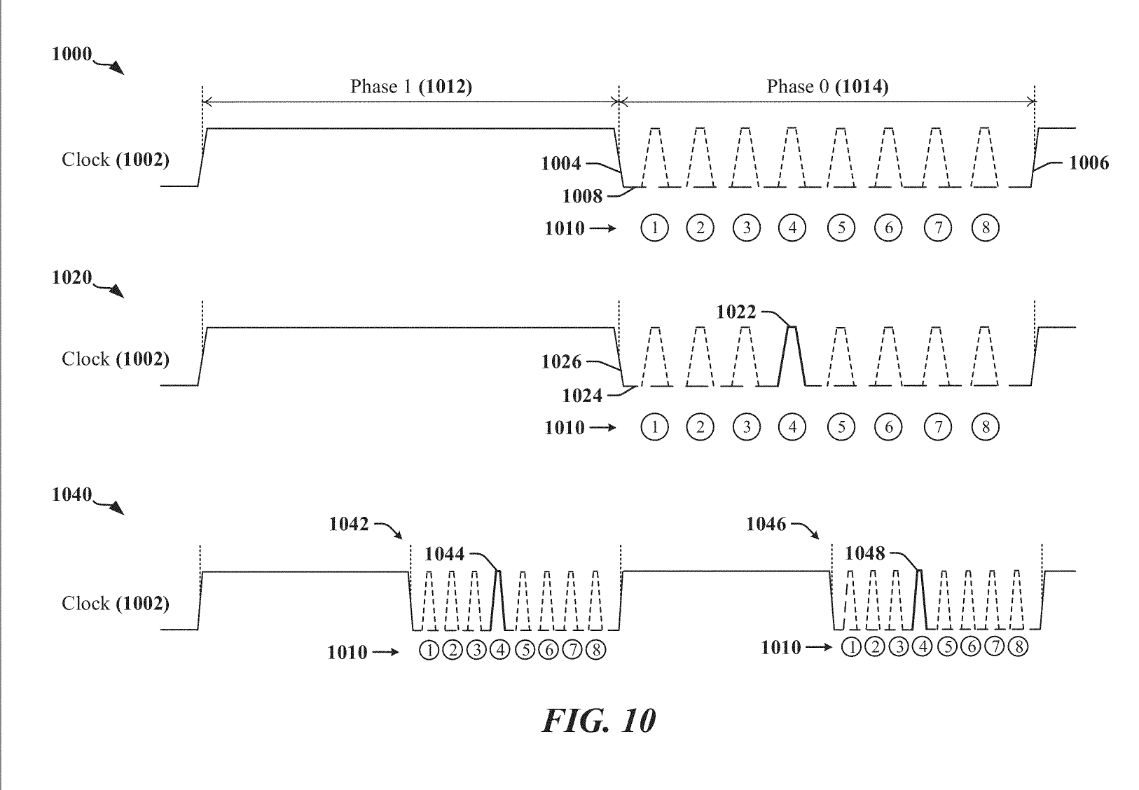

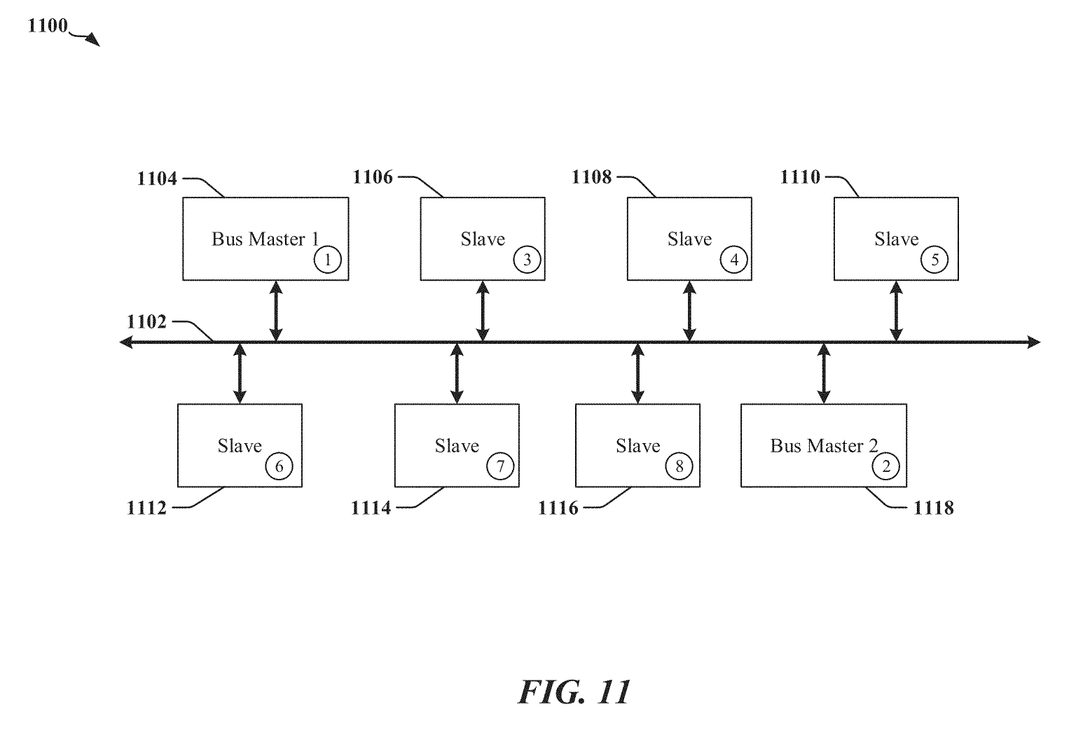

FIG. 10 includes timing diagrams 1000, 1020, 1040 illustrating an example of additional pulses that may be used to encode information in accordance with certain aspects disclosed herein. In the example, pulse position modulation (PPM) is employed to provide signaling opportunities in timeslots 1010 that permit information, alerts, and/or exceptions to be asserted in the system 1100 illustrated in FIG. 11, for example. In one example, the position of a pulse with respect to one or more edges 1004, 1006 of a clock signal transmitted on a clock line 1002 may identify a device launching the pulse. In another example, the position of the pulse with respect to a center point between the edges 1004, 1006 of the clock signal may identify the device launching the pulse. The presence of one or more pulses may indicate that a bus pre-emption is requested.

Each of the timeslots 1010 may be assigned to a device 1104, 1106, 1108, 1110, 1112, 1114, 1116, 1118 coupled to a serial bus 1102. In one example, earlier occurring timeslots 1010 may be assigned to master devices 1104, 1118. In another example, certain timeslots 1010 may be assigned according to device priority. A number (N) of sub-divisions of the clock phase (i.e., phase 1 1012 or phase 0 1014) may be defined to accommodate 1 to N PPM pulses and enable resolution of the identity of a device 1104, 1106, 1108, 1110, 1112, 1114, 1116, 1118 that is requesting pre-emption within a clock cycle. In some instances, a single device can request pre-emption, and N=1.

A current bus master device 1104 or 1118 may interpret a detected PPM pulse 1022 as a bus pre-emption request by the device 1108 that launched the PPM pulse 1022. In certain implementations, the current bus master device 1104 or 1118 may be configured to terminate a current transmission after detecting a first PPM pulse 1022. In some instances, the current bus master device 1104 or 1118 may be configured to terminate a current transmission after detecting PPM pulses 1044, 1048 that are repeated in a number of successive clock cycles. As illustrated, the PPM pulses 1044, 1048 are repeated in the same phases 1042, 1046 of two successive clock cycles. The use of repeated PPM pulses 1044, 1048 may mitigate noise-related issues that can cause false detection of PPM pulses.

Arbitration may be performed when multiple devices 1104, 1106, 1108, 1110, 1112, 1114, 1116, 1118 drive a pulse in the same clock cycle and/or same phase of the clock cycle. In one example, a simple round-robin scheme may provide equal access to the serial bus 1102 while avoiding servicing of excessive bus requests by any one device 1104, 1106, 1108, 1110, 1112, 1114, 1116, 1118.

An output of a line driver in the current bus master device 1104 or 1118 may enter a high-impedance state 1008, 1024 after driving an edge 1004, 1026 of the clock signal transmitted on a clock line 1002. The clock line 1002 may be held in the low state by a pull-down resistor, keeper circuit, or other circuit. One or more of the devices 1104, 1106, 1108, 1110, 1112, 1114, 1116, 1118 that desires or needs to request access to the serial bus 1102 may enable respective line drivers during their assigned timeslots 1010 in order to drive a PPM pulse 1022, 1044, 1048. Devices 1104, 1106, 1108, 1110, 1112, 1114, 1116, 1118 that do not desire or need access to the serial bus 1102 may leave their respective line drivers in a high impedance state during their assigned timeslots 1010.

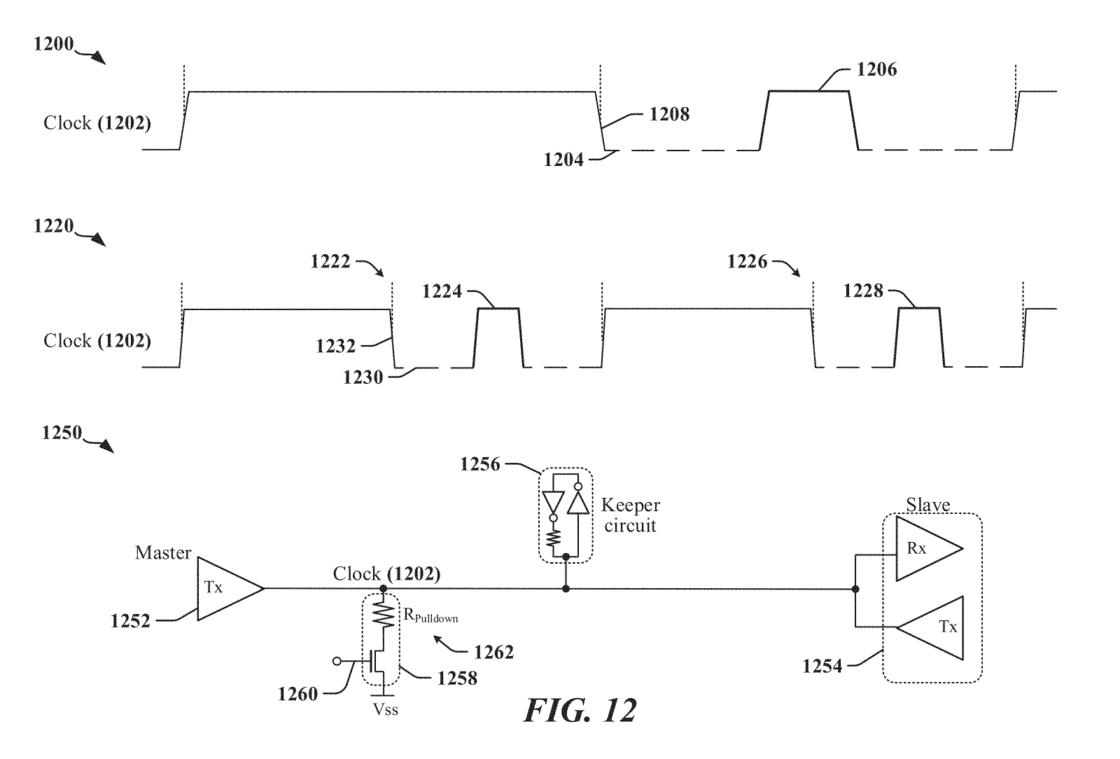

FIG. 12 includes timing diagrams 1200, 1220 illustrating a second example of the use of additional pulses 1206, 1224, 1228 to encode information. In this example, PPM may be implemented to provide signaling opportunities to request and/or initiate a handover between master devices 1104, 1118 on a two-master serial bus implementation. In this example, the additional pulses 1206, 1224, 1228 may have a longer duration, since information need not be encoded in the position of the additional pulses 1206, 1224, 1228 with respect to any edge or center of a clock phase.

A current bus master device 1104 or 1118 may interpret an additional pulse 1206 as a bus ownership request by the other bus master device 1118 or 1104, which launched the additional pulse 1206. In certain implementations, the current bus master device 1104 or 1118 may be configured to terminate a current transmission after detecting a first PPM pulse 1224. In some implementations, the current bus master device 1104 or 1118 may be configured to terminate a current transmission after detecting additional pulses 1224, 1228 that are repeated in a number of successive clock cycles. As illustrated, the additional pulses 1224, 1228 are repeated in the same phases 1222, 1226 of the successive clock cycles. The use of repeated additional pulses 1224, 1228 may mitigate noise related issues that can cause false detection of PPM pulses.

An output of a line driver in the current bus master device 1104 or 1118 may enter a high-impedance state 1204, 1230 after driving an edge 1208, 1232 of the clock signal transmitted on a clock line 1202. The clock line 1202 may be held in the low state by a pull-down resistor 1262, keeper circuit 1256, or other circuit. A master device 1118 or 1104 that desires or needs to gain control of the serial bus 1102 may enable a line driver in order to drive a PPM pulse 1224, 1228.

FIG. 12 illustrates an example of line termination 1250 that may employ a keeper circuit 1256 or a switchable pull-down 1258 to facilitate pre-emption requests in accordance with certain aspects disclosed herein. In some implementations, the output of a line driver 1252 of a bus master may present a high impedance to the clock line 1202 that permits a transceiver 1254 of a slave device to drive the clock line 1202 without contention. The clock line 1202 may be held in the low state using the keeper circuit 1256 or the switchable pull-down 1258. In one example, the keeper circuit 1256 may be configured as a positive feedback circuit that drives the clock line 1202 through a high impedance output, and receives feedback from the clock line 1202 through a low impedance input. The keeper circuit 1256 may be configured to maintain the last asserted voltage on the clock line 1202. The keeper circuit 1256 can be easily overcome by line drivers 1252 in the bus master or slave device. In another example, a pull-down resistor 1262 may be coupled to the clock line 1202 through a switch controlled by a pull-down enable signal 1260.

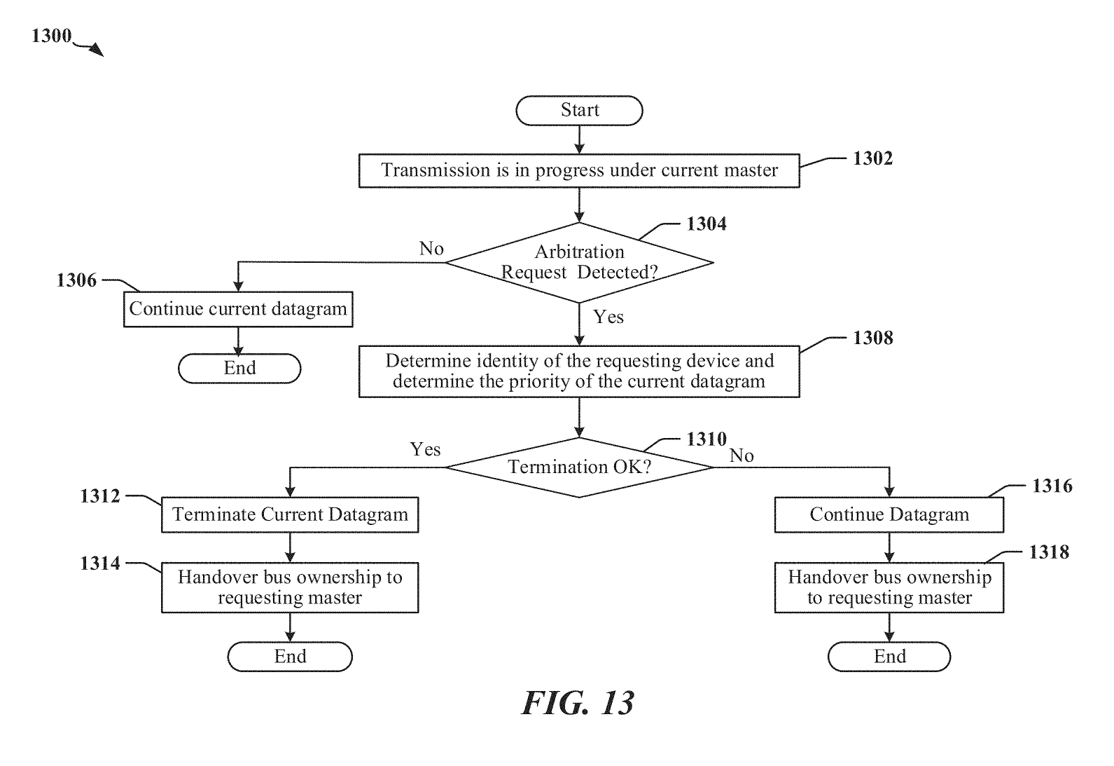

FIG. 13 is a flowchart 1300 illustrating a process that may be used to request and/or initiate a bus handover. At block 1302, a current bus master device 1104 or 1118 may be engaged in exchange of a datagram. The current bus master device 1104 or 1118 may be transmitting or receiving. The current bus master device 1104 or 1118 may monitor one or both phases of a bus clock signal transmitted on the clock line 1202 to determine if the other bus master device 1118 or 1104 has driven an additional pulse 1206 or combination of pulses 1206, 1224, 1228 on the clock line 1202. An additional pulse 1206 or combination of pulses 1224, 1228 may indicate a request for bus ownership. The request for bus ownership may be handled as a request for arbitration to determine which current bus master device 1104 or 1118 is to control the serial bus. If no request for arbitration is determined at block 1304, then the current bus master device 1104 or 1118 may continue with exchange of the current datagram at block 1306. If a request for arbitration is determined at block 1304, then the current bus master device 1104 or 1118 may identify the requesting bus master device 1118 or 1104 at block 1308. When more than two bus master devices 1104 or 1118 are coupled to the serial bus, the current bus master device 1104 or 1118 may determine identity of the requesting bus master device 1118 or 1104 based on position of the pulse in the clock signal.

At block 1308, the current bus master device 1104 or 1118 may determine if the requesting bus master device 1118 or 1104 has a greater priority than the current bus master device 1104 or 1118. If at block 1310 the current bus master device 1104 or 1118 determines that ownership of the serial bus should be handed over to the requesting bus master device 1118 or 1104, then the current bus master device 1104 or 1118 may terminate transmission of the current datagram at block 1312 before handing over bus ownership to the requesting bus master device 1118 or 1104 at block 1314.

If at block 1310 the current bus master device 1104 or 1118 determines that ownership of the serial bus should not be handed over to the requesting bus master device 1118 or 1104, then the current bus master device 1104 or 1118 may continue with exchange of the current datagram at block 1316. The current bus master device 1104 or 1118 may hand over bus ownership to the requesting bus master device 1118 or 1104 at block 1318. The use of PPM based signaling scheme may be precluded in systems where clock signals have periods that limit the number of pulse positions available per phase of the clock signal.

### PWM Pre-Emption Requests Transmitted on a Clock Line of a Serial Bus

Certain aspects disclosed herein relate to the use of pulse width modulation (PWM) on the clock signal of a serial bus to provide a multipurpose signaling scheme on a multi-point serial bus that couples multiple devices. The use of PWM may allow more than one bit to be encoded per clock pulse, where encoding is based on duty cycle classifications. In certain implementations, the clock line of the serial bus may be driven by one or more devices in addition to the current bus master. The clock line may be driven by these devices to signal an alert condition using a PWM scheme with built-in drive-conflict-avoidance.

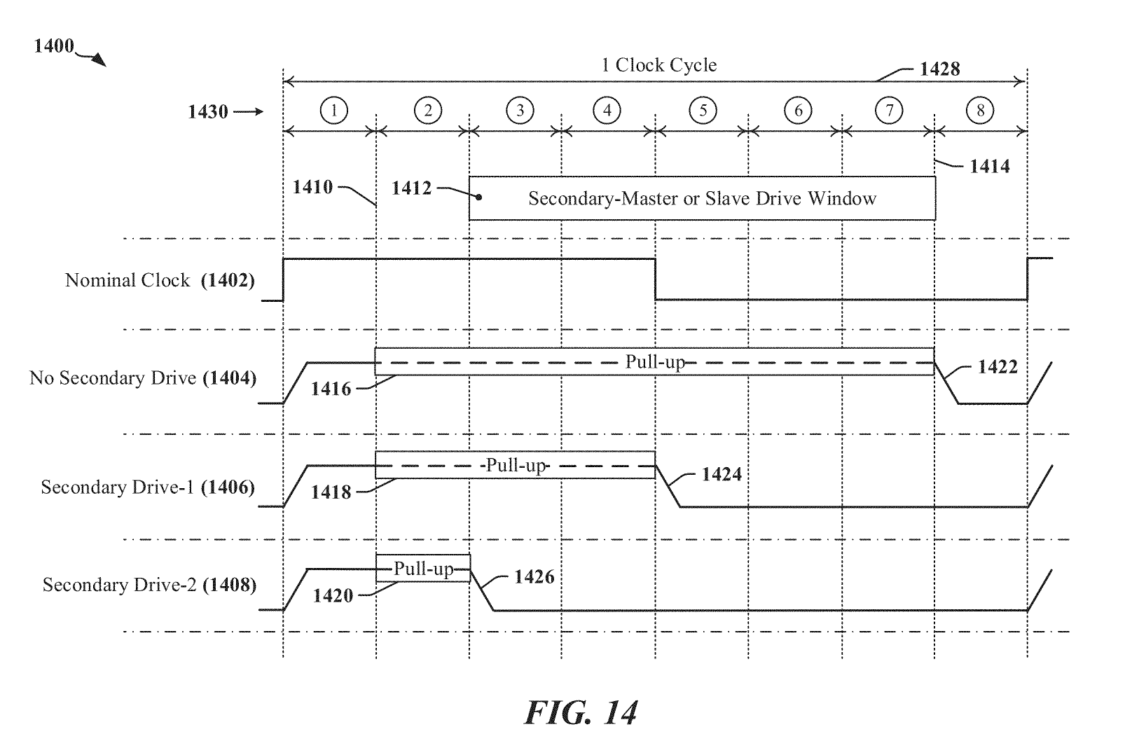

FIG. 14 is a timing diagram 1400 that illustrates certain aspects of a PWM-based signaling scheme in accordance with certain aspects disclosed herein. The timing diagram 1400 illustrates a full-cycle 1428 of a clock signal transmitted on a serial bus. A nominal clock signal 1402 has 50% duty cycle, which is shown as being divided into 8 slots 1430.

In one aspect, a current master device is coupled to the serial bus through a bidirectional transceiver. The master device provides bus timing that controls transmission of data bits on the data line. The master device may be adapted to drive the clock line until a time 1410 corresponding to the end of a first slot. The master device may drive the clock line high and enters a high-impedance mode, which may be accomplished by causing the transceiver to operate as a receiver. The clock line is in a pulled-up state 1416, 1418, 1420 through the operation of a keeper circuit, which weakly holds the state of the clock line. A slave device or secondary master device may drive the clock line low, overcoming the keeper circuit, when the slave device or secondary master device wishes to signal an alert. The master device monitors the line and, upon detecting an early transition 1424, 1426 to the low state, recommences driving the clock line, thereby terminating the pulled-up state 1418, 1420. In one example 1404, no slave device or secondary master device wishes to signal an alert, and the current master drives the clock line low at the end 1414 of a window 1412 defined for slave device or secondary master device alerts. The resulting transition 1422 to the low state terminates the pulled-up state 1416.

One or more bits of data may be encoded in timing of the high-to-low transition 1422, 1424, 1426. For example, a normal, later transition 1422 may encode a bit value of 0, while an early transition 1424, 1426 may encode a bit value of 1. In two examples 1406, 1408, the slave device or secondary master device is shown as driving the clock signal low. The two examples 1406, 1408 may represent timing variations in the alert generation scheme. In some instances, the slave device or secondary master device may be able to more closely control the driving of the clock line such that one of four (or more) transition times may be identifiable and multiple bits may be encoded in each clock cycle.

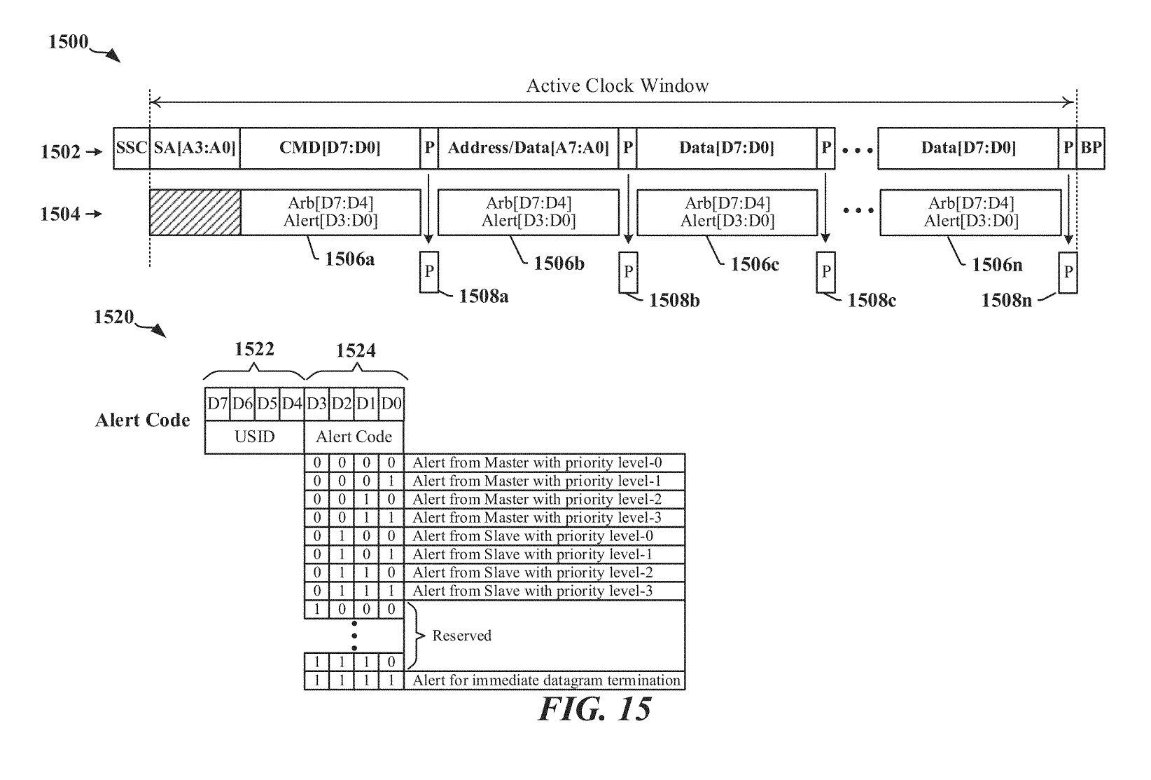

FIG. 15 illustrates an example of a signaling structure 1500 that may support alert transmissions by a slave device or secondary master device. In one example, a current bus master may transmit a forward datagram 1502 to a secondary master or slave device over the data line, and the secondary master or slave device may transmit a reverse datagram 1504 on the clock line. The slave device or secondary master device may transmit one or more 8-bit arbitration/alert bytes 1506a-1506n on the clock line using PWM while a command, address or payload data field is transmitted on the data line. The slave device or secondary master device may provide a parity bit concurrently with parity transmitted on the data line. Typically, arbitration/alert data are not transmitted while slave addresses are transmitted.

FIG. 15 includes a table 1520 illustrating one example of arbitration/alert bytes 1506a-1506n encoding. A first four bits 1522 of each arbitration/alert byte 1506a-1506n is used to identify a slave device or secondary master device that prevailed in arbitration. A second four bits 1524 of each arbitration/alert byte 1506a-1506n includes an alert code, which may identify a type and/or source of the alert and a priority level for the alert. In one example, the alert code may identify the source to be a master and the alert may cause a handover of bus ownership. In another example, the alert code may identify the source to be a slave and the alert may initiate communication between the current bus master and the slave. In another example, the alert code may cause immediate termination of the current datagram in order to process a critical alert.

The coding scheme can indicate request-urgency in terms of a binary-weighted 4-bit symbol. Multiple devices may launch critical alerts over the same reverse datagram. The current bus master can automatically resolve bus access priority after launch of the alert conditions. In some implementations, the coding system enables conventional arbitration schemes to be eliminated. For example, an SPMI-like arbitration may take place after the current datagram has been transmitted, and the scheme disclosed herein provides the current master with alert codes that enable arbitration to be performed without further signaling. A currently active low-priority datagram may be terminated prematurely terminated by the current Master when a very high priority alert is received from any other device on the serial bus.

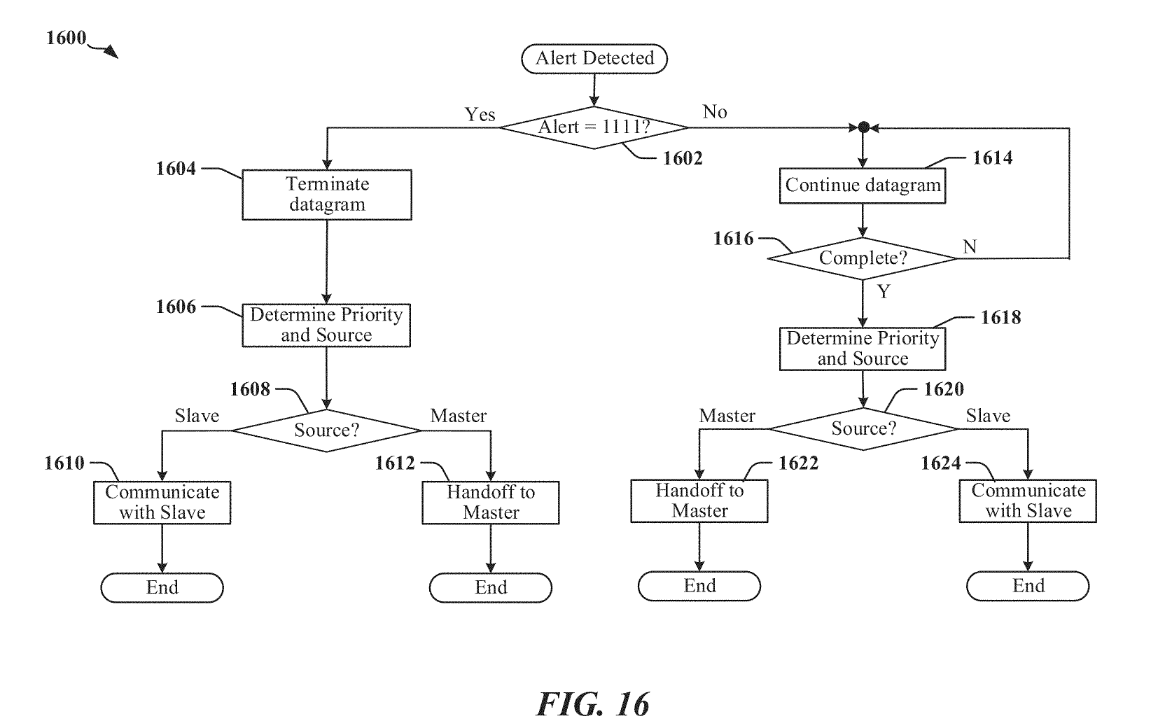

FIG. 16 is a flowchart 1600 illustrating a process that may be used to handle arbitration/alert byte 1506a-1506n generated from PWM encoding on the clock signal. The process may commence when an alert is detected, typically by decoding PWM information from the clock signal. At block 1602, a current bus master device may determine whether a critical alert has been received. The critical alert may have an alert code with a binary value of 1111. If a critical code has been received, the current bus master device may terminate the current datagram prematurely at block 1604. The current bus master device may determine priority and source of the alert at block 1606. If at block 1608 the current bus master device identifies the source as a slave device, the current bus master device may initiate communication with the slave device at block 1610. If at block 1608 the current bus master device identifies the source as a secondary master device, the current bus master device may initiate a handover of ownership of the serial bus to the secondary master device at block 1612.

If at block 1602 the current bus master device determines that a critical code has not been received, the current bus master device may continue exchange of the current datagram at block 1614 until the current bus master device determines that datagram has been completely transmitted at block 1616. The current bus master device may then determine priority and source of the alert at block 1618. If at block 1620 the current bus master device identifies the source to be a secondary master device, the current bus master device may initiate a handover of ownership of the serial bus to the secondary master device at block 1622. If at block 1620 the current bus master device identifies the source as a slave device, the current bus master device may initiate communication with the slave device at block 1624.

### Full-Duplex Communication Using a Clock Line of a Serial Bus

Certain aspects disclosed herein provide systems, apparatus and techniques that enable a receiving device to simultaneously transmit data over a serial bus that conventionally is limited to half-duplex operation. Increasing instances of time-critical use cases indicate a need for full-duplex capabilities over a serial bus deployed within mobile communication devices. In various examples, certain buses operated in accordance with I3C, RFFE and/or SPMI protocols may be adapted to support full-duplex operation.

In one example, the clock line may be driven by multiple entities coupled to the serial bus in order to request access to the bus and participate in bus arbitration. A device that wins the bus arbitration can transmit data over the clock line using a PWM scheme with built-in drive-conflict-avoidance. Transmissions over the clock line may employ a coding scheme that indicates an intent to transmit data, and a quantity of the data to be transmitted, which may range from a minimum transmission of 1-Byte to a transmission of N Bytes.

According to certain aspects, a device coupled to a serial bus may be adapted to provide a dual-port interface that can support full-duplex communication. Conventional devices that include a dual-port interface to the data line (SDATA) line may be adapted for full-duplex communication by instantiating a dual-port interface to the clock line (SCLOCK).

In some instances, additional clock cycles may be transmitted to support longer datagram transmissions over the clock-line when the message transmitted on the data line ends first due to relatively smaller datagram.

In some implementations, protocols governing operations on the serial bus may be adapted to support transmission of data over the clock line. In one example, the conventional Bus Park Cycle (BPC) defined by SPMI or RFFE protocols may be omitted from transmissions on the data line when the end of a datagram transmitted over the clock line is indicated by a byte-count provided in the header portion of the datagram.

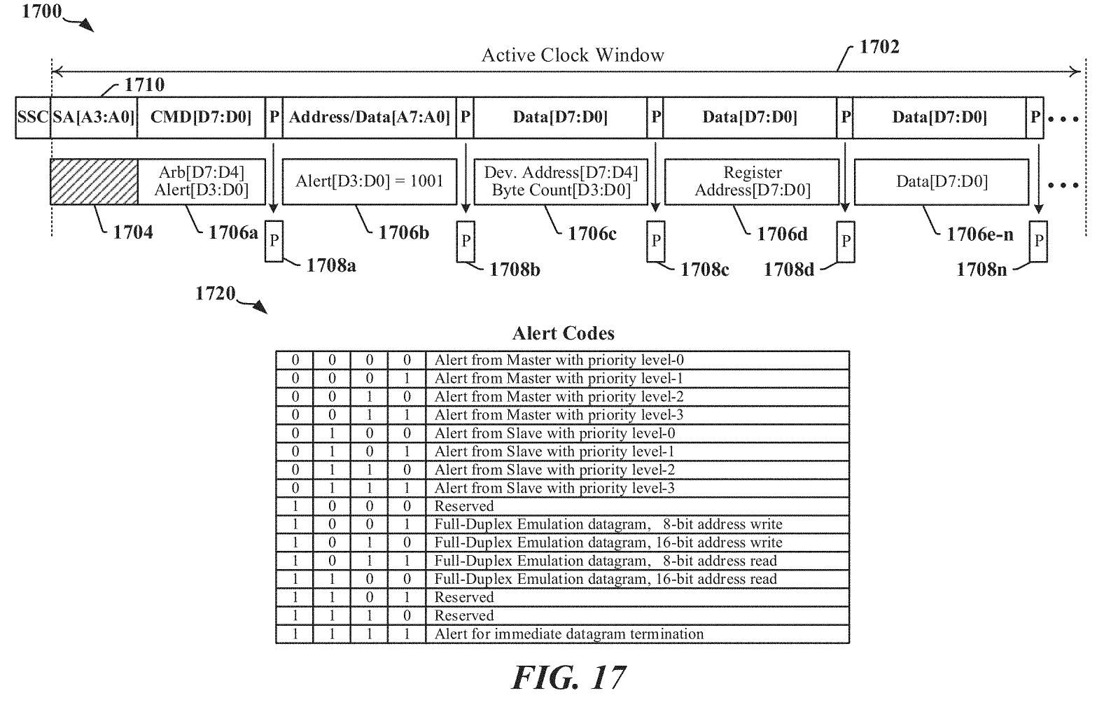

FIG. 17 illustrates an example of a datagram 1700 that may support alert transmissions by a slave device or secondary master device. The 4-bit initial arbitration slot 1704 corresponding to the SA field 1710 transmitted on the data line may be used for bus arbitration. In one example, a zero value transmitted in the initial arbitration slot 1704 may cause the unconditional termination of the datagram transmitted on the data line, while a non-zero value relates to a bus arbitration where the winning master device obtains bus ownership after the transmission of the current datagram. A winning master device launches the clock signal. Data transmissions over the clock line may occur during an active clock window 1702 when no arbitration has occurred during the initial arbitration slot 1704. For example, each of the arbitration/alert bytes 1706a-1706n may be available for alerts and arbitration after an absence of arbitration in the initial arbitration slot 1704. An alert code may be defined to indicate an intent to transmit data on the clock line by an arbitration winning device.

FIG. 17 includes a table 1720 illustrating one example of alert codes that may be transmitted in arbitration/alert bytes 1706a-1706n provided by encoding a clock signal. In one example, the table 1720 in FIG. 17 is an expanded version of the table 1520 in FIG. 15. A first four bits of each the arbitration/alert byte 1706a-1706n may be used to identify a slave device or secondary master device that prevailed in arbitration. A second four bits of each arbitration/alert byte 1706a-1706n includes an alert code, which may identify a type and source of the alert, and a priority level for the alert. In one example, the alert code may identify the source to be a server and the alert may cause a handover of bus ownership. In another example, the alert code may identify the source to be a slave and the alert may initiate communication between the current bus master and the slave. In another example, the alert code may cause immediate termination of the current datagram in order to process a critical alert. Parity bits 1708a-1708n may be transmitted to indicate parity over the arbitration/alert bytes 1706a-1706n.

In the datagram 1700 an alert code of value 1001 may be transmitted in an arbitration/alert byte 1706b to indicate an intent to write data on the clock line by an arbitration winning device. The following transmission opportunity (arbitration/alert byte 1706c) may be used to transmit an address of the device to which data is to be written, and a byte count identifying the size of data payload to be transmitted over the clock line. A register address may be transmitted (in arbitration/alert byte 1706d) identifying the starting register in the device to which data is to be written. One or more data bytes may then be transmitted (in arbitration/alert byte(s) 1706e-n).

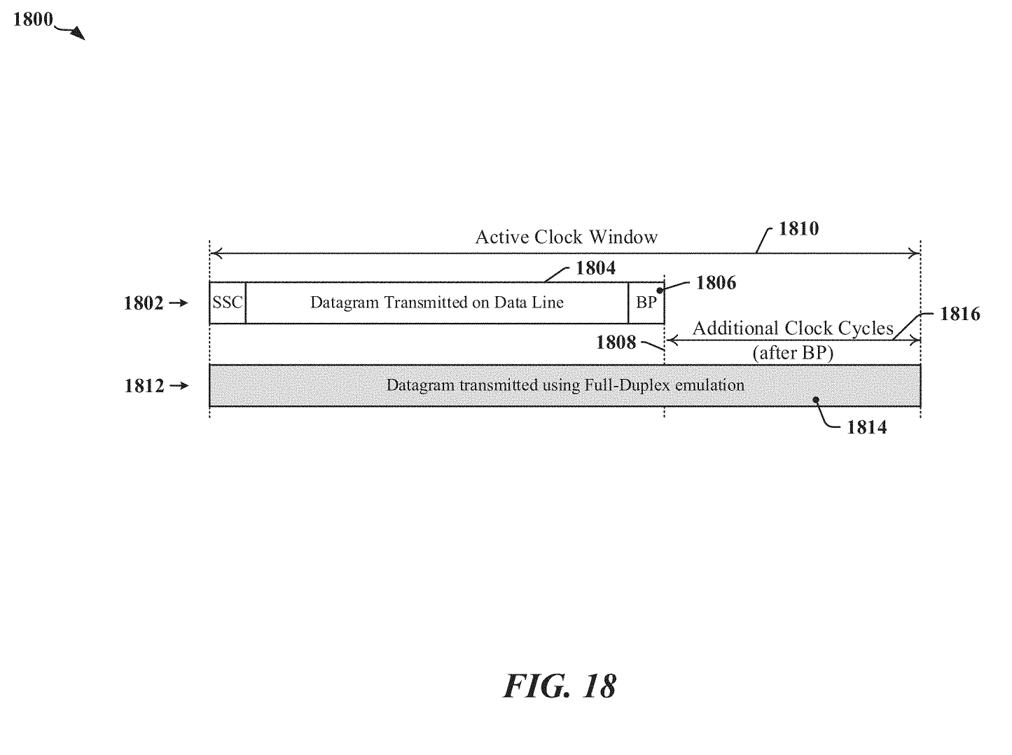

FIG. 18 illustrates timing 1800 of additional clock cycles 1816 that may be transmitted to support full-duplex emulation during an active clock window 1810 in accordance with certain aspects disclosed herein. In some instances, a primary datagram 1804 sent over the data line 1802 may terminate before a secondary datagram 1814 has been fully transmitted in full-duplex emulation mode over the clock line 1812. In conventional systems, the master device terminates the clock signal after completion of transmission 1808 of the bus park cycle 1806 that is provided after the primary datagram 1804. When the clock signal is suspended, data transmission in PWM-based full-duplex emulation mode ceases.

In some aspects, the master device may provide additional clock cycles 1816 sufficient to complete transmission of the secondary datagram 1814. The master device can calculate the number of additional clock cycles 1816 based on information provided in the header of the secondary datagram 1814. For example, the address of the device to which data is to be written may be transmitted with a byte count identifying the size of data payload to be transmitted over the clock line. In one example, the master device may calculate the number of additional clock cycles 1816 from the byte count. In another example, the master may use bit-counters loaded with information from the byte count to determine when clock cycles are no longer needed for full-duplex emulation.

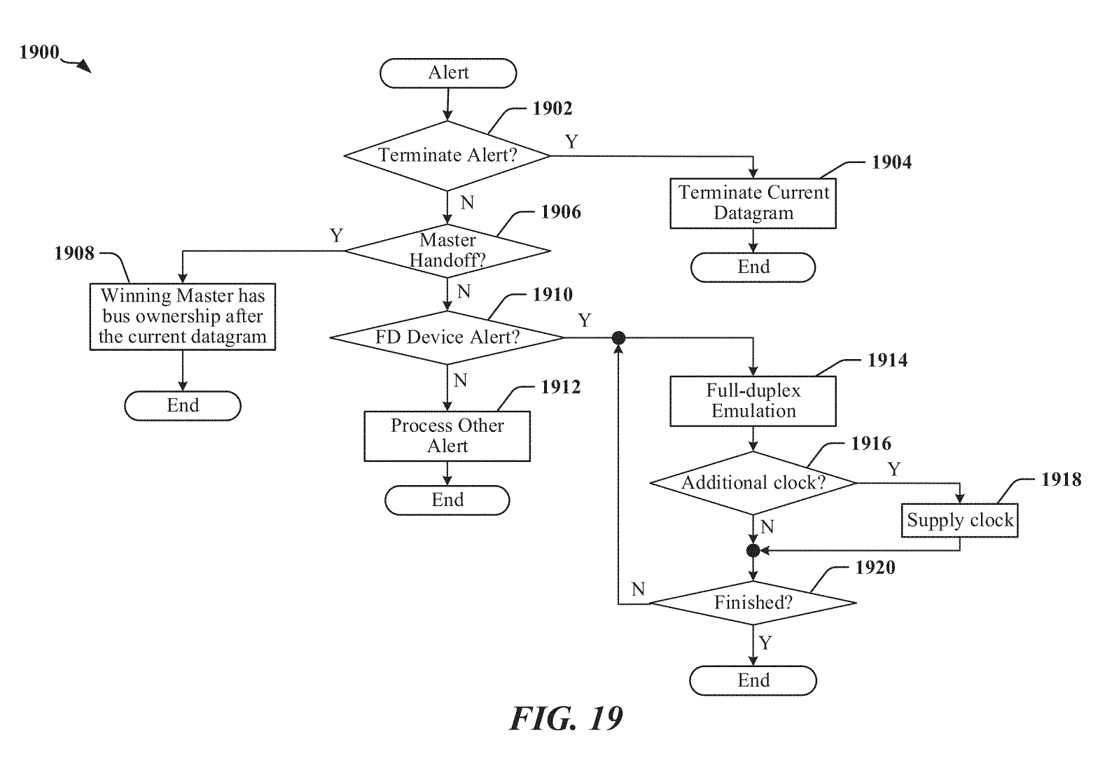

FIG. 19 is a flowchart 1900 illustrating a process that may be used to implement full-duplex emulation in accordance with certain aspects disclosed herein. The process may be initiated after detection of an alert. At block 1902, the current master device may determine whether the alert includes a critical termination request. When the alert includes a critical termination request, then the current master device terminates the current datagram at block 1904 and the process may be terminated. When the alert does not include a critical termination request, then the current master device may determine at block 1906 whether the alert includes a master handoff request. When the alert includes a master handoff request, then the current master device may transfer bus ownership at block 1908 to the winning device after transmission of the current datagram has been completed.

When the current master determines that the alert does not include a master handoff request, then the current master device may determine at block 1910 whether the alert includes an indication of full-duplex emulation. When the alert does not include an indication of full-duplex emulation, then the current master device may process the alert as an ordinary alert at block 1912. When the alert includes an indication of full-duplex emulation, then the current master device may begin full-duplex emulation mode transmissions at block 1914. At block 1916, the current master device may determine from time-to-time whether additional clock cycles are needed. Additional clock cycles may be needed when transmission of the primary datagram 1804 has completed while the secondary datagram 1814 is being transmitted. If the current master device determines that additional clock cycles are needed, then the additional clock cycles may be provided at block 1918. If the current master device determines that additional clock cycles are not needed, then the current master device may determine at block 1920 whether the secondary datagram 1814 has been completely transmitted. When the secondary datagram 1814 has not been completely transmitted, the full-duplex emulation transmissions continue at block 1914. When the secondary datagram 1814 has been completely transmitted, the process may be terminated.

### Examples of Processing Circuits and Methods

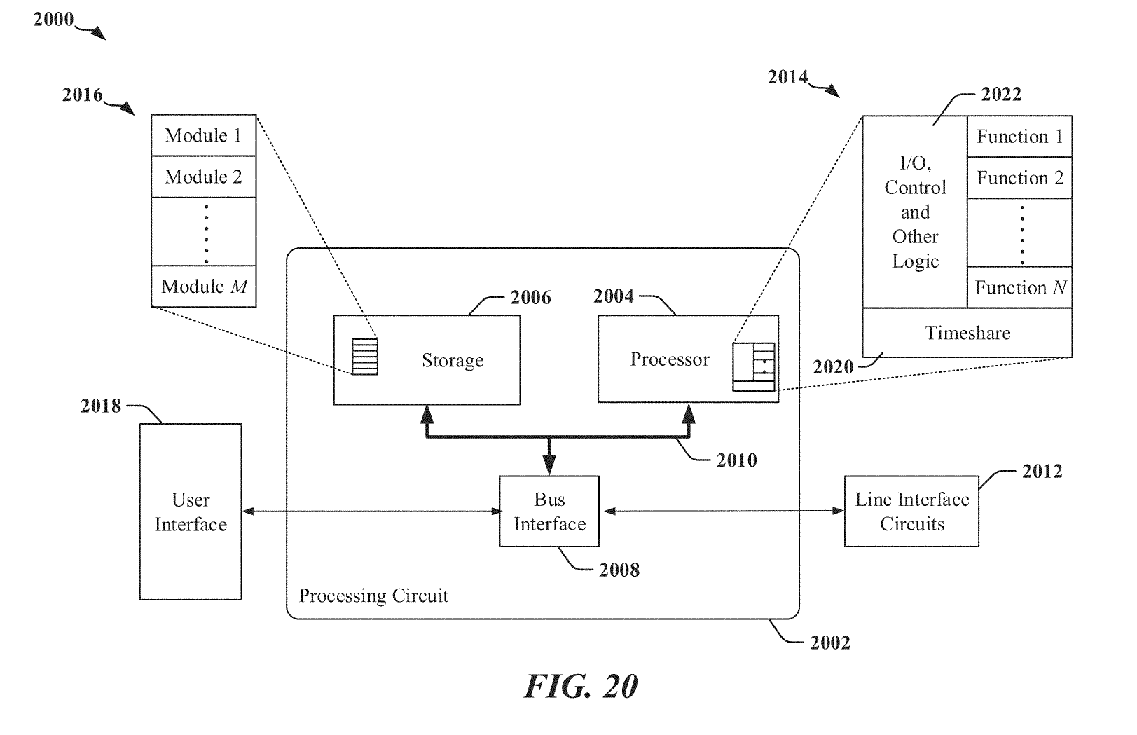

FIG. 20 is a diagram illustrating an example of a hardware implementation for an apparatus 2000 employing a processing circuit 2002 that may be configured to perform one or more functions disclosed herein. In accordance with various aspects of the disclosure, an element, or any portion of an element, or any combination of elements as disclosed herein may be implemented using the processing circuit 2002. The processing circuit 2002 may include one or more processors 2004 that are controlled by some combination of hardware and software modules. Examples of processors 2004 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2004 may include specialized processors that perform specific functions, and that may be configured, augmented or controlled by one of the software modules 2016. The one or more processors 2004 may be configured through a combination of software modules 2016 loaded during initialization, and further configured by loading or unloading one or more software modules 2016 during operation. In various examples, the processing circuit 2002 may be implemented using a state machine, sequencer, signal processor and/or general-purpose processor, or a combination of such devices and circuits.

In the illustrated example, the processing circuit 2002 may be implemented with a bus architecture, represented generally by the bus 2010. The bus 2010 may include any number of interconnecting buses and bridges depending on the specific application of the processing circuit 2002 and the overall design constraints. The bus 2010 links together various circuits including the one or more processors 2004, and storage 2006. Storage 2006 may include memory devices and mass storage devices, and may be referred to herein as computer-readable media and/or processor-readable media. The bus 2010 may also link various other circuits such as timing sources, timers, peripherals, voltage regulators, and power management circuits. A bus interface 2008 may provide an interface between the bus 2010 and one or more transceivers 2012. A transceiver 2012 may be provided for each networking technology supported by the processing circuit. In some instances, multiple networking technologies may share some or all of the circuitry or processing modules found in a transceiver 2012. Each transceiver 2012 provides a means for communicating with various other apparatus over a transmission medium. Depending upon the nature of the apparatus 2000, a user interface 2018 (e.g., keypad, display, speaker, microphone, joystick) may also be provided, and may be communicatively coupled to the bus 2010 directly or through the bus interface 2008.

A processor 2004 may be responsible for managing the bus 2010 and for general processing that may include the execution of software stored in a computer-readable medium that may include the storage 2006. In this respect, the processing circuit 2002, including the processor 2004, may be used to implement any of the methods, functions and techniques disclosed herein. The storage 2006 may be used for storing data that is manipulated by the processor 2004 when executing software, and the software may be configured to implement any one of the methods disclosed herein.

One or more processors 2004 in the processing circuit 2002 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2006 or in an external computer-readable medium. The external computer-readable medium and/or storage 2006 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2006 may also include, by way of example, a carrier wave, a transmission line, and any other suitable medium for transmitting software and/or instructions that may be accessed and read by a computer. Computer-readable medium and/or the storage 2006 may reside in the processing circuit 2002, in the processor 2004, external to the processing circuit 2002, or be distributed across multiple entities including the processing circuit 2002. The computer-readable medium and/or storage 2006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2006 may maintain software maintained and/or organized in loadable code segments, modules, applications, programs, etc., which may be referred to herein as software modules 2016. Each of the software modules 2016 may include instructions and data that, when installed or loaded on the processing circuit 2002 and executed by the one or more processors 2004, contribute to a run-time image 2014 that controls the operation of the one or more processors 2004. When executed, certain instructions may cause the processing circuit 2002 to perform functions in accordance with certain methods, algorithms and processes described herein.

Some of the software modules 2016 may be loaded during initialization of the processing circuit 2002, and these software modules 2016 may configure the processing circuit 2002 to enable performance of the various functions disclosed herein. For example, some software modules 2016 may configure internal devices and/or logic circuits 2022 of the processor 2004, and may manage access to external devices such as the transceiver 2012, the bus interface 2008, the user interface 2018, timers, mathematical coprocessors, and so on. The software modules 2016 may include a control program and/or an operating system that interacts with interrupt handlers and device drivers, and that controls access to various resources provided by the processing circuit 2002. The resources may include memory, processing time, access to the transceiver 2012, the user interface 2018, and so on.

One or more processors 2004 of the processing circuit 2002 may be multifunctional, whereby some of the software modules 2016 are loaded and configured to perform different functions or different instances of the same function. The one or more processors 2004 may additionally be adapted to manage background tasks initiated in response to inputs from the user interface 2018, the transceiver 2012, and device drivers, for example. To support the performance of multiple functions, the one or more processors 2004 may be configured to provide a multitasking environment, whereby each of a plurality of functions is implemented as a set of tasks serviced by the one or more processors 2004 as needed or desired. In one example, the multitasking environment may be implemented using a timesharing program 2020 that passes control of a processor 2004 between different tasks, whereby each task returns control of the one or more processors 2004 to the timesharing program 2020 upon completion of any outstanding operations and/or in response to an input such as an interrupt. When a task has control of the one or more processors 2004, the processing circuit is effectively specialized for the purposes addressed by the function associated with the controlling task. The timesharing program 2020 may include an operating system, a main loop that transfers control on a round-robin basis, a function that allocates control of the one or more processors 2004 in accordance with a prioritization of the functions, and/or an interrupt driven main loop that responds to external events by providing control of the one or more processors 2004 to a handling function.

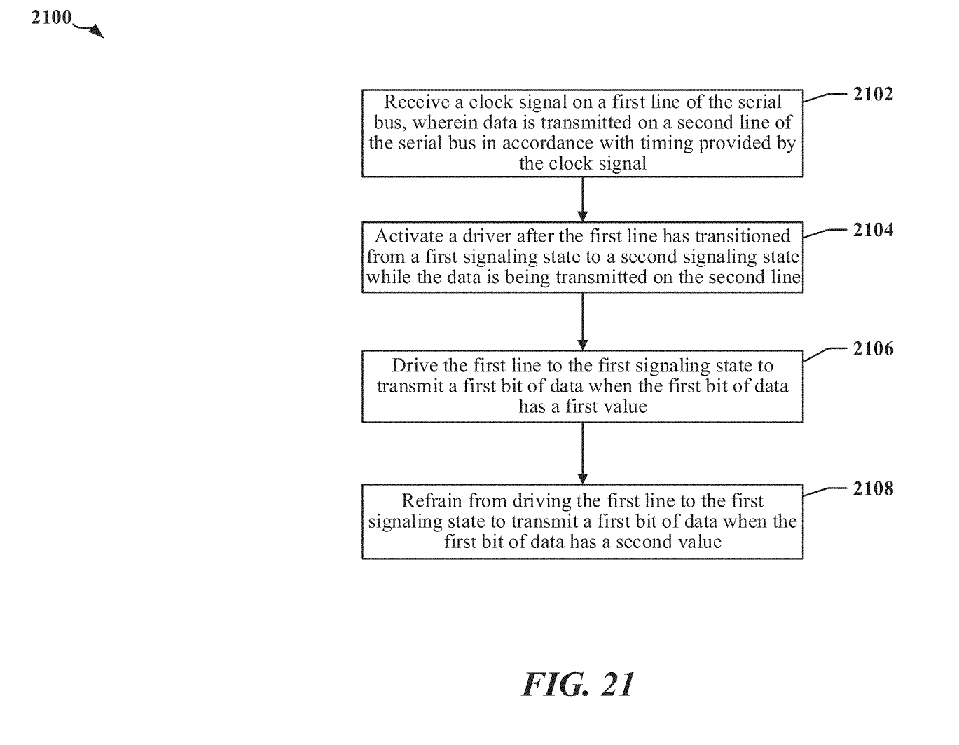

FIG. 21 is a flowchart 2100 illustrating a process that may be performed at a device coupled to a serial bus. At block 2102, the device may receive a clock signal on a first line of the serial bus. Data may be transmitted on a second line of the serial bus in accordance with timing provided by the clock signal. At block 2104, the device may activate a driver after the first line has transitioned from a first signaling state to a second signaling state while the data is being transmitted on the second line. At block 2106, the device may drive the first line to the first signaling state to transmit a first bit of data when the first bit of data has a first value. At block 2108, the device may refrain from driving the first line to the first signaling state to transmit a first bit of data when the first bit of data has a second value.

In one example, the first bit of data may be included in an alert code transmitted on the first line. The method may include encoding priority information in the alert code. The alert code may be transmitted with arbitration information, and the method may include encoding an address identifying a source of the alert code in the arbitration information.

In some examples, the first line is maintained in the second signaling state by a keeper circuit after the first line has transitioned from the first signaling state to the second signaling state.

In one example, the device may obtain ownership of the serial bus after the alert code is transmitted on the first line. In another example, the device may communicate with a bus master device after the alert code is transmitted on the first line. Transmission of a datagram may be prematurely terminated after the alert code is transmitted on the first line.

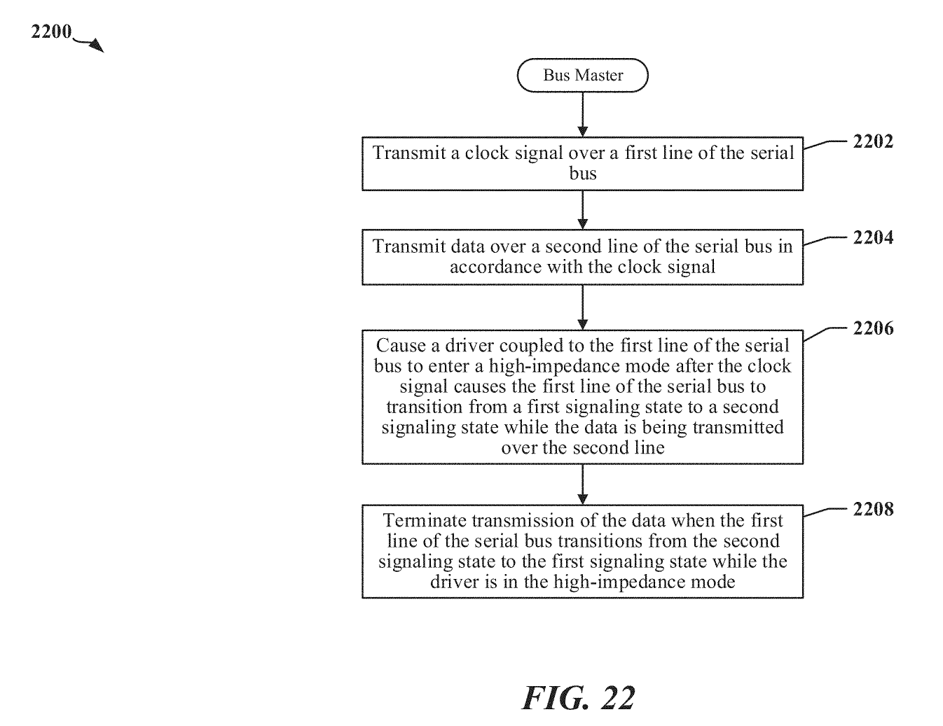

FIG. 22 is a flowchart 2200 illustrating a process that may be performed at a device coupled to a serial bus. The device may be configured to operate as a bus master on the serial bus.

At block 2202, the device may transmit a clock signal over a first line of the serial bus. At block 2204, the device may transmit data over a second line of the serial bus in accordance with the clock signal. At block 2206, the device may cause a driver coupled to the first line of the serial bus to enter a high-impedance mode after the clock signal causes the first line of the serial bus to transition from a first signaling state to a second signaling state while the data is being transmitted over the second line. At block 2208, the device may terminate transmission of the data when the first line of the serial bus transitions from the second signaling state to the first signaling state while the driver is in the high-impedance mode.

In some implementations, the device may identify a device that causes the first line of the serial bus to transition to the first signaling state based on a timeslot during which the serial bus transitions to the first signaling state. A plurality of timeslots may be provided for a phase of the clock signal. The device may cause the driver coupled to the first line of the serial bus to drive the first line of the serial bus to the second signaling state prior to commencement of each of the plurality of timeslots. The device may cause the driver coupled to the first line of the serial bus to enter the high-impedance mode after the commencement of each of the plurality of timeslots.

In some instances, the device may identify a plurality of devices that cause the first line of the serial bus to transition to the first signaling state in different timeslots provided in a phase of the clock signal. Each of the plurality of devices may be uniquely associated with one of the different timeslots, and the device may communicate with a first device in the plurality of devices after terminating the transmission of the data. The device may select the first device from the plurality of devices based on a priority defined by a timeslot associated with the first device. In one example, earlier-occurring timeslots have a high priority than later-occurring timeslots.

In some implementations, the device may initiate a handover of ownership of the serial bus to a secondary bus master after terminating the transmission of the data.

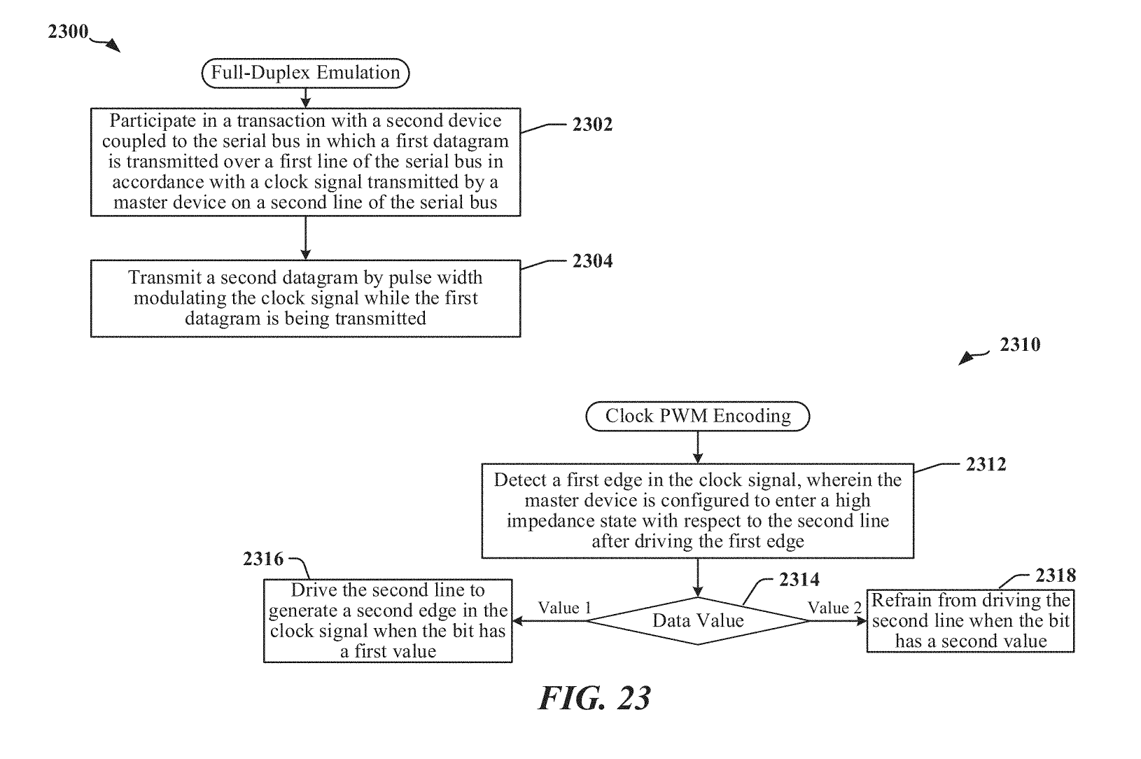

FIG. 23 includes flowcharts 2300, 2310, where one flowchart 2300 illustrates certain aspects of a process for full-duplex emulation that may be performed at a first device coupled to a serial bus. At block 2302, the first device may participate in a transaction with a second device coupled to the serial bus in which a first datagram is transmitted over a first line of the serial bus in accordance with a clock signal transmitted by a master device on a second line of the serial device. At block 2304, the first device may transmit a second datagram by pulse width modulating the clock signal while the first datagram is being transmitted. The second datagram may be transmitted in accordance with the procedure illustrated in the second flowchart 2310. In some examples, the master device is the first device or the second device.

The other flowchart 2310 relates to certain aspects of the operation of the master device during full-duplex emulation. In the other flowchart 2310, the first device may detect a first edge in the clock signal at block 2312. The master device may be configured to enter a high impedance state with respect to the second line after driving the first edge. At block 2314, may determine the value of a data bit. At block 2316, the first device may drive the second line to generate a second edge in the clock signal when the bit has a first value. At block 2318, the first device may refrain from driving the second line when the bit has a second value.

In various examples, the master device reactivates its driver coupled to the clock signal to drive the second edge after a configured reverse drive window if not other device has provided the second edge. In one example, the master device reactivates its driver early and provides the second edge in order to send data over the second line. In the latter example, the first device includes and/or operates the master device.

In one example, the first device may transmit an alert over the serial bus by pulse width modulating the clock signal while the first datagram is being transmitted to initiate transmission of the second datagram. The alert may include an alert code defining a priority for the second datagram and an alert code defining direction of transmission.

In another example, the first device may receive an alert over the serial bus by pulse width modulating the clock signal while the first datagram is being transmitted, the alert indicating that transmission of the second datagram is commencing. The alert may include an alert code defining a priority for the second datagram and an alert code defining direction of transmission.

In some examples, the second datagram includes size field indicating a size of data to be transmitted in a payload of the second datagram. The first device may be a bus master device. The first device may provide additional clock cycles in the clock signal after completing transmission of the first datagram when transmission of the second datagram has not been completed. The additional clock cycles may be provided in a quantity calculated based on a value provided in the size field.

In one example, the alert may include an arbitration field and an alert code defining a transaction to be conducted by pulse width modulating the clock signal.

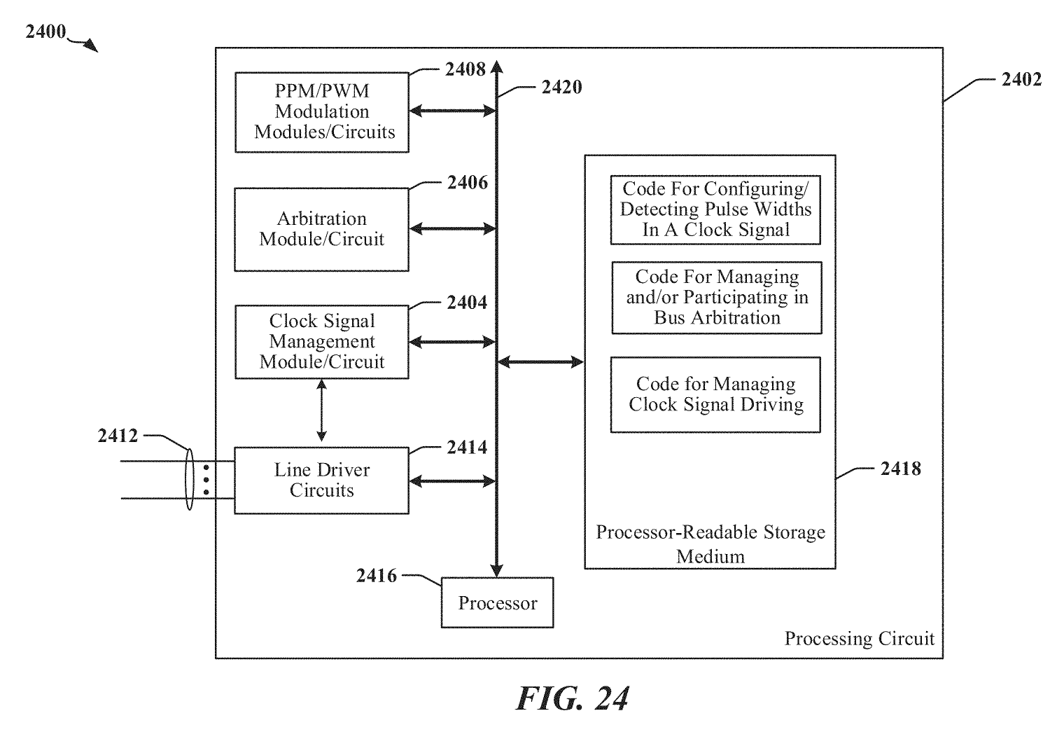

FIG. 24 is a diagram illustrating a simplified example of a hardware implementation for an apparatus 2400 employing a processing circuit 2402. The processing circuit typically has a controller or processor 2416 that may include one or more microprocessors, microcontrollers, digital signal processors, sequencers and/or state machines. The processing circuit 2402 may be implemented with a bus architecture, represented generally by the bus 2420. The bus 2420 may include any number of interconnecting buses and bridges depending on the specific application of the processing circuit 2402 and the overall design constraints. The bus 2420 links together various circuits including one or more processors and/or hardware modules, represented by the controller or processor 2416, the modules or circuits 2404, 2406 and 2408, and the computer-readable storage medium 2418. The apparatus may be coupled to a multi-wire communication link using a physical layer circuit 2414. The physical layer circuit 2414 may operate the multi-wire serial bus 2412 to support communications in accordance with I3C protocols. The bus 2420 may also link various other circuits such as timing sources, peripherals, voltage regulators, and power management circuits, which are well known in the art, and therefore, will not be described any further.

The processor 2416 is responsible for general processing, including the execution of software, code and/or instructions stored on the computer-readable storage medium 2418. The computer-readable storage medium may include a non-transitory storage medium. The software, when executed by the processor 2416, causes the processing circuit 2402 to perform the various functions described supra for any particular apparatus. The computer-readable storage medium may be used for storing data that is manipulated by the processor 2416 when executing software. The processing circuit 2402 further includes at least one of the modules 2404, 2406 and 2408. The modules 2404, 2406 and 2408 may be software modules running in the processor 2416, resident/stored in the computer-readable storage medium 2418, one or more hardware modules coupled to the processor 2416, or some combination thereof. The modules 2404, 2406 and 2408 may include microcontroller instructions, state machine configuration parameters, or some combination thereof.

In one configuration, the apparatus 2400 includes clock signal management modules and/or circuits 2404, and physical layer circuits 2414 that provide a first line driver coupled to a first wire of a multi-wire serial bus and a second line driver coupled to a second wire of the multi-wire serial bus 2412. The apparatus 2400 may include modules and/or circuits 2408 configured to control or detect timing on the clock signal of the serial bus related to PPM and/or PWM encoding, and modules and/or circuits 2406 configured to arbitrate between devices contending for access to the serial bus.

In a first example, the apparatus 2400 may have a processor 2416 and an interface circuit. The processor 2416 may be configured to provide an alert code for transmission over a first line of the serial bus while data is transmitted by another device over a second line of the serial bus. The interface circuit may include a line driver coupled to the first line of the serial bus, and the data may be transmitted over the second line of the serial bus in accordance with timing provided by a clock signal received from the first line of the serial bus. The interface circuit may be configured to detect that the clock signal has transitioned from a first signaling state to a second signaling state while the data is being transmitted over the second line, activate the line driver after the first line of the serial bus has transitioned from the first signaling state to the second signaling state when a first bit of the alert code has a first value, drive the first line of the serial bus to the first signaling state to transmit a first bit of data when the first bit of the alert code has the first value, and refrain from driving the first line when the first bit of data of the alert code has a second value. The alert code may be transmitted on the first line of the serial bus with arbitration information, and an address identifying a source of the alert code. The first line of the serial bus may be maintained in the second signaling state by a keeper circuit after the first line of the serial bus has transitioned from the first signaling state to the second signaling state.

The processor may be further configured to obtain ownership of the serial bus after the alert code is transmitted on the first line of the serial bus. A command transmitted by a bus master device may be received from the second line of the serial bus after the alert code is transmitted on the first line of the serial bus. Transmission of a datagram may be prematurely terminated after the alert code is transmitted on the first line of the serial bus.

In a second example, the apparatus 2400 may have a processor 2416 and an interface circuit. The interface circuit may be configured to transmit a clock signal over a first line of the serial bus, and transmit data over a second line of the serial bus in accordance with the clock signal. The processor 2416 may be configured to cause a driver coupled to the first line of the serial bus to enter a high-impedance mode after the clock signal causes the first line of the serial bus to transition from a first signaling state to a second signaling state while the data is being transmitted over the second line, and terminate transmission of the data when the first line of the serial bus transitions from the second signaling state to the first signaling state while the driver is in the high-impedance mode. The processor may be further configured to identify a device that causes the first line of the serial bus to transition to the first signaling state based on a timeslot during which the serial bus transitions to the first signaling state. A plurality of timeslots may be provided for a phase of the clock signal. The processor may be further configured to cause the driver coupled to the first line of the serial bus to drive the first line of the serial bus to the second signaling state prior to commencement of each of the plurality of timeslots, and cause the driver coupled to the first line of the serial bus to enter the high-impedance mode after the commencement of each of the plurality of timeslots.

The processor may be further configured to identify a plurality of devices that cause the first line of the serial bus to transition to the first signaling state in different timeslots provided in a phase of the clock signal. Each of the plurality of devices is uniquely associated with one of the different timeslots. The processor may be further configured to communicate with a first device in the plurality of devices after terminating the transmission of the data. The processor may be further configured to select the first device from the plurality of devices based on a priority defined by a timeslot associated with the first device. Earlier-occurring timeslots may have a high priority than later-occurring timeslots. The processor may be further configured to initiate a handover of ownership of the serial bus to a secondary bus master after terminating the transmission of the data.

In a third example, the apparatus 2400 has a bus interface configured to couple the apparatus to a serial bus, the bus interface including a line driver adapted to drive a first line of the serial bus. The apparatus 2400 may include a controller configured to participate in a transaction with another device coupled to the serial bus in which a first datagram is transmitted over the first line of the serial bus in accordance with a clock signal transmitted by a master device on a second line of the serial device, and cause the bus interface to pulse width modulate a second datagram. The second datagram may be pulse width modulated by detecting a first edge in the clock signal, driving the second line to generate a second edge in the clock signal when the bit has a first value, and refraining from driving the second line when the bit has a second value. The master device may be configured to enter a high impedance state with respect to the second line after driving the first edge. The master device may be configured to exit the high impedance state after a time corresponding to a configured maximum pulse width if not other device has provided the second edge. In some implementations, the master device may provide the second edge before the time corresponding to the maximum pulse width in order to transmit data over the clock line.

In a fourth example, the computer-readable storage medium 2418 may store code for implementing the method illustrated in FIG. 21, including instructions for receiving a clock signal on a first line of the serial bus. Data may be transmitted on a second line of the serial bus in accordance with timing provided by the clock signal, activating a driver after the first line has transitioned from a first signaling state to a second signaling state while the data is being transmitted on the second line, driving the first line to the first signaling state to transmit a first bit of data when the first bit of data has a first value, and refraining from driving the first line to the first signaling state to transmit a first bit of data when the first bit of data has a second value.

In a fifth example, the computer-readable storage medium 2418 may store code for implementing the method illustrated in FIG. 22, including instructions for transmitting a clock signal over a first line of the serial bus, transmitting data over a second line of the serial bus in accordance with the clock signal, causing a driver coupled to the first line of the serial bus to enter a high-impedance mode after the clock signal causes the first line of the serial bus to transition from a first signaling state to a second signaling state while the data is being transmitted over the second line, and terminating transmission of the data when the first line of the serial bus transitions from the second signaling state to the first signaling state while the driver is in the high-impedance mode.

In a sixth example, the computer-readable storage medium 2418 may store code for implementing the method illustrated in FIG. 23, including instructions for participating in a transaction with a second device coupled to the serial bus in which a first datagram is transmitted over a first line of the serial bus in accordance with a clock signal transmitted by a master device on a second line of the serial device, transmitting a second datagram by pulse width modulating the clock signal while the first datagram is being transmitted. The code may include instructions for detecting a first edge in the clock signal, wherein the master device is configured to enter a high impedance state with respect to the second line after driving the first edge, driving the second line to generate a second edge in the clock signal when the bit has a first value, and refraining from driving the second line when the bit has a second value.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for transmitting data over a serial bus comprising:
receiving a clock signal on a first line of the serial bus, wherein the data is transmitted on a second line of the serial bus in accordance with timing provided by the clock signal;
activating a driver after the first line has transitioned from a first signaling state to a second signaling state while the data is being transmitted on the second line;
driving the first line to the first signaling state to transmit a first bit of data when the first bit of data has a first value; and
refraining from driving the first line to the first signaling state to transmit the first bit of data when the first bit of data has a second value.

2. The method of claim 1, wherein the first bit of data is included in an alert code transmitted on the first line.

3. The method of claim 2, further comprising:
encoding priority information in the alert code.

4. The method of claim 2, wherein the alert code is transmitted with arbitration information, and further comprising:
encoding an address identifying a source of the alert code in the arbitration information.

5. The method of claim 1, wherein the first line is maintained in the second signaling state by a keeper circuit after the first line has transitioned from the first signaling state to the second signaling state.

6. The method of claim 2, further comprising:
obtaining ownership of the serial bus after the alert code is transmitted on the first line.

7. The method of claim 2, further comprising:
receiving a command transmitted by a bus master device from the second line of the serial bus after the alert code is transmitted on the first line of the serial bus.

8. The method of claim 2, wherein transmission of a datagram is prematurely terminated after the alert code is transmitted on the first line.

9. An apparatus adapted for communicating over a serial bus comprising:
a processor configured to provide an alert code for transmission on a first line of the serial bus while data is transmitted by another device on a second line of the serial bus; and
an interface circuit adapted to couple the apparatus to the serial bus, wherein the interface circuit comprises:
a line driver coupled to the first line of the serial bus, wherein the data is transmitted on the second line of the serial bus in accordance with timing provided by a clock signal received from the first line of the serial bus, and
wherein the interface circuit is configured to:
detect that the clock signal has transitioned from a first signaling state to a second signaling state while the data is being transmitted on the second line;
activate the line driver after the first line of the serial bus has transitioned from the first signaling state to the second signaling state when a first bit of the alert code has a first value;
drive the first line of the serial bus to the first signaling state to transmit a first bit of data when the first bit of the alert code has the first value; and
refrain from driving the first line when the first bit of the alert code has a second value.

10. The apparatus of claim 9, wherein the alert code is transmitted on the first line of the serial bus with arbitration information, and an address identifying a source of the alert code.

11. The apparatus of claim 9, wherein the first line of the serial bus is maintained in the second signaling state by a keeper circuit after the first line of the serial bus has transitioned from the first signaling state to the second signaling state.

12. The apparatus of claim 9, wherein the processor is further configured to obtain ownership of the serial bus after the alert code is transmitted on the first line of the serial bus.

13. The apparatus of claim 9, wherein a command transmitted by a bus master device is received from the second line of the serial bus after the alert code is transmitted on the first line of the serial bus.

14. The apparatus of claim 9, wherein transmission of a datagram is prematurely terminated after the alert code is transmitted on the first line of the serial bus.

15. A method implemented at a first device coupled to a serial bus, the method comprising:
participating in a transaction with a second device coupled to the serial bus in which a first datagram is transmitted on a first line of the serial bus in accordance with a clock signal transmitted by a master device on a second line of the serial bus; and
transmitting a second datagram by pulse width modulating the clock signal while the first datagram is being transmitted, wherein a bit of the second datagram is encoded in the clock signal by:
detecting a first edge in the clock signal, wherein the master device is configured to enter a high impedance state with respect to the second line after driving the first edge;
driving the second line to generate a second edge in the clock signal when the bit has a first value; and
refraining from driving the second line when the bit has a second value.

16. The method of claim 15, further comprising:
transmitting an alert over the serial bus by pulse width modulating the clock signal while the first datagram is being transmitted to initiate transmission of the second datagram.

17. The method of claim 16, wherein the alert comprises an alert code defining a priority for the second datagram and an alert code defining direction of transmission.

18. The method of claim 15, further comprising:
receiving an alert from the clock signal while the first datagram is being transmitted, wherein the alert is encoded in the clock signal using pulse width modulation, and wherein the alert indicates that transmission of the second datagram is commencing.

19. The method of claim 18, wherein the alert comprises an alert code defining a priority for the second datagram and a direction of transmission of the second datagram.

20. The method of claim 15, wherein the second datagram includes a size field indicating a size of data to be transmitted in a payload of the second datagram.

21. The method of claim 20, wherein the first device is a bus master device and further comprising:
providing additional clock cycles in the clock signal after completing transmission of the first datagram when transmission of the second datagram has not been completed.

22. The method of claim 21, wherein the additional clock cycles are provided in a quantity calculated based on a value provided in the size field.

23. The method of claim 15, wherein an alert transmitted over the serial bus comprises an arbitration field and an alert code defining a transaction to be conducted by pulse width modulating the clock signal.

24. An apparatus operable for transmitting data over a serial bus comprising:
a bus interface configured to couple the apparatus to the serial bus, the bus interface including a line driver adapted to drive a first line of the serial bus; and
a controller configured to:
participate in a transaction with another device coupled to the serial bus in which a first datagram is transmitted on the first line of the serial bus in accordance with a clock signal transmitted by a master device on a second line of the serial bus; and
cause the bus interface to pulse width modulate each bit of a second datagram by:
detecting a first edge in the clock signal, wherein the master device is configured to enter a high impedance state with respect to the second line after driving the first edge;
driving the second line to generate a second edge in the clock signal when the bit has a first value; and
refraining from driving the second line when the bit has a second value.

25. The apparatus of claim 24, wherein the controller is configured to:
transmit an alert over the serial bus by pulse width modulating the clock signal while the first datagram is being transmitted to initiate transmission of the second datagram.

26. The apparatus of claim 25, wherein the alert comprises an alert code defining a priority for the second datagram and a direction of transmission of the second datagram.

27. The apparatus of claim 24, wherein the controller is configured to:
receive an alert over the serial bus by pulse width modulating the clock signal while the first datagram is being transmitted, the alert indicating that transmission of the second datagram is commencing,
wherein the alert comprises an alert code defining a priority for the second datagram and an alert code defining direction of transmission.

28. The apparatus of claim 24, wherein the second datagram includes a size field indicating a size of data to be transmitted in a payload of the second datagram.

29. The apparatus of claim 28, wherein the apparatus is a bus master device, and wherein the controller is configured to:
provide additional clock cycles in the clock signal after completing transmission of the first datagram when transmission of the second datagram has not been completed.

30. The apparatus of claim 29, wherein the controller is configured to:
calculate a quantity of the additional clock cycles based on a value provided in the size field.
